(19) United States
(12) Patent Application Publication
(10) Pub. No.: US 2025/0266464 A1
(43) Pub. Date: Aug. 21, 2025

(54) ELECTRODE COMPOSITE MATERIALS, ELECTRODES COMPRISING SAME, AND ALL SOLID STATE BATTERIES COMPRISING SAME, AND METHODS OF MAKING SAME

(71) Applicants: LG Energy Solution, Ltd., Seoul (KR); The Regents of the University of California, Oakland, CA (US)

(72) Inventors: Jeongbeom Lee, Daejeon (KR); Min Sang Song, Daejeon (KR); Ying Shirley Meng, San Diego, CA (US); Ashley Cronk, La Jolla, CA (US)

(21) Appl. No.: 19/058,845

(22) Filed: Feb. 20, 2025

Related U.S. Application Data
(60) Provisional application No. 63/555,694, filed on Feb. 20, 2024.
(60) Provisional application No. 63/760,919, filed on Feb. 20, 2025.

(51) Int. Cl. H01M 4/62; B60L 50/64; H01M 4/136; H01M 4/58

(52) U.S. Cl. CPC H01M 4/628; B60L 50/64; H01M 4/136; H01M 4/5815; H01M 4/625; H01M 2220/20

(57) ABSTRACT

An electrode composite material and a method of making same are disclosed. A mixture that includes lithium sulfide (Li₂S) particles containing a Li₂S compound, carbon particles, and halogenated lithium phosphorous sulfide (LPS-X) particles containing an LPS-X (X is F, Cl, Br, and/or I) compound are provided. The LPS-X particles have crystallinity which can be confirmed with XRD of the LPS-X particles or the mixture showing XRD peaks indicative of crystalline LPS-X. The mixture does not include lithium phosphorous sulfide (LPS) particles made of an LPS compound. The mixture is ball-milled to provide a ball-milled composite material. At least part of the LPS-X compound contained in at least part of the LPS-X particles is converted to the LPS compound. XRD of the ball-milled composite material shows none of the XRD peaks indicative of crystalline LPS-X.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure relates to electrode composite materials, electrodes, and all solid state batteries, and methods of making electrode composite materials, electrodes, and all solid state batteries.

### Secondary Batteries

Secondary batteries have become increasingly desirable power sources for a wide range of various electronic devices, such as cars, computers, cell phones, tools, scooter, bikes, electronic automobiles, power storage systems, drones, and other devices. Among secondary batteries, lithium-based batteries have gained particular prominence due to their ability to provide a desirable balance of voltage and energy density. In addition to their performance advantages, lithium ion secondary batteries contribute to addressing climate change by enabling the electrification of transportation and facilitating the integration of renewable energy sources. These batteries help reduce greenhouse gas emissions by powering electric vehicles and storing energy from intermittent renewable sources like solar and wind. Furthermore, the long cycle life and high energy density of lithium ion batteries may support the development of smart grids and decentralized energy systems, potentially improving overall energy efficiency and reducing reliance on fossil fuels. Traditionally, lithium secondary batteries include a liquid electrolyte, typically comprising a lithium salt dissolved in an organic solvent. However, there has been growing interest in developing an all solid-state lithium secondary battery as an alternative to conventional liquid electrolyte-based systems. Solid-state batteries offer potential advantages in terms of safety, stability, and energy density. Despite these potential benefits, the development of practical all solid-state lithium secondary batteries faces several significant challenges.

### Challenges of All Solid-State Secondary Batteries

One challenge in solid-state battery design is achieving and maintaining sufficient lithium ion diffusivity within the solid electrolyte material. Further, volume changes (e.g. swelling and shrinking) of certain components of the battery—such as the electrode—may occur during discharging and charging of the battery. These volume changes may lead to mechanical stress or result in a loss of contact between various components within the battery structure. The loss of contact between battery components can cause degradation of charging and discharging characteristics, as well as deterioration of overall battery capacity. Researchers and engineers in the field of energy storage are actively working to address these challenges. Efforts are focused on developing new materials and battery designs that can achieve desirable lithium ion diffusivity while also accommodating the mechanical stresses associated with battery cycling. Improving the stability of interfaces within solid-state batteries remains an area of investigation. Overcoming the current limitations of solid-state battery systems could potentially lead to significant advancements in energy storage capabilities for a wide range of applications.

### Lithium-Sulfur Batteries

Lithium-sulfur batteries possess the ability to disrupt current lithium-ion battery technology due to its low cost, high theoretical capacity, 1675 mAh g⁻¹ and 1166 mAh g⁻¹ for sulfur and lithium sulfide (Li₂S), respectively, and projected gravimetric energy density (>500 Wh kg⁻¹)¹⁻³, required to trigger a paradigm shift for currently inaccessible technologies like electrified aviation.^{4,5} Its low cost and high abundancy make sulfur an excellent material to be used for next generation energy storage. Despite its promise, its implementation within the market has been hindered by copious intrinsic and interfacial challenges that originate from the conversion cathode material itself when used with liquid-based electrolytes. These hurdles include the electronic and ionic insulating properties of Li₂S and sulfur^{6,7}, large volume expansion upon (de)lithiation^{8,9}, and polysulfide dissolution^{10,11}, where soluble redox intermediates (Li₂Sₓ, 3<x<8) dissolve in the liquid electrolyte triggering a “shuttling effect” of once active material from the cathode to the Li metal anode, leading to irreversible mass and capacity loss upon cycling.¹² The slow reaction kinetics coupled with liquid electrolyte incompatibility are the main culprits currently limiting its practicality for widescale adoption.

### Cathode Architectures of Lithium-Sulfur Batteries

A wide variety of materials to cell level engineering strategies have been explored to realize lithium sulfur technology in the liquid system. Innovative cathode architectures have been demonstrated to combat the volume expansion effects^{13,14} and/or boost sulfur loadings¹⁵⁻¹⁸, by constraining the sulfur active material while also providing a porous yet highly conductive surface area network for sufficient electrochemical reaction sites. However, when designed for higher loadings¹⁹, utilization and cyclability often are compromised and rely heavily on elevated temperatures or modified electrolyte strategies²⁰ to overcome still present kinetic limitations. To combat this, redox mediators are often introduced to regulate conversion reactions, alter formation kinetics, and reduce overall cell polarization.²¹ Various classes have been investigated in elemental sulfur cathodes like pseudocapacitive oxide species²², titanium silicates²³, and organic-based polymers²⁴. Specifically, for the Li₂S cathode, metallocenes²⁵, organic-based²⁶, or even solid-state electrolytes^{27,28} have been employed to mitigate the large activation barrier evident during delithiation. Adding redox mediators, while helpful in alleviating unwanted degradation, can impact practicality by additional mass within the cell, lowering the energy density of the system. While all these strategies have shown some improvement in performance, large trade-offs are still made on either cycle life, active material loading, or utilization.

### Solid-State Electrolytes for Lithium-Sulfur Batteries

Despite the immense efforts to develop new cathode architectures, modify liquid electrolyte chemistry, and incorporate redox mediators to alleviate capacity loss, the future of lithium sulfur chemistry in the liquid system remains to be uncertain. High-capacity sulfur-based cathodes can overcome the energy density and cost of conventional lithium-ion batteries. However, its development has been hindered by an intrinsic polysulfide dissolution within liquid electrolytes, resulting in irreversible capacity loss and poor cycling performance. The challenges present mainly originate from the instability of the liquid electrolyte with the polysulfide species, which are unavoidable. Replacing the liquid electrolyte with a compatible solid-state electrolyte (SSE) can possibly eliminate polysulfide dissolution all together. Work by Cao et al. used operando Raman spectroscopy to confirm the elimination of the polysulfide “shuttling effect” in all solid-state²⁹, reinforcing the motivation to move away from liquid to solid electrolytes. Thus, prior works have explored this option, exploring the feasibility of lithium sulfur chemistry in various classes of SSEs. Sulfide-based electrolytes are a popular choice and mainly have been explored, for their high ionic conductivities^{30,31} favorable mechanical properties^{32,33} and dry room compatibility³⁴. These properties make sulfide-based electrolytes the most qualified to tackle the requirements for lithium sulfur chemistry and scale up. Furthermore, molecular dynamic simulations found sulfide SSEs to be the most thermodynamically stable against the sulfur cathode compared to other SSE classes.³⁵ Prior work thus far has capitalized on various sulfide SSEs like thiophosphates Li₃PS₄ (LPS)³⁶, glass ceramic (Li₃PS₄-2LiBH₄)³⁷, with most utilizing the argyrodite Li₆PS₅Cl (LPSCl)³⁸⁻⁴³ solid electrolyte. A lot of effort has been invested in cathode composite engineering, investigating synthesis methods that achieve intimate cathode/SSE contact to facilitate reversible electrochemical behavior. Despite the favorable electrochemical and mechanical properties that sulfide SSEs possess, enabling a practical all solid-state lithium sulfur battery with high utilization, areal capacities, and good cycling stability has still yet to be reported. This has been attributed to (chemo)mechanical failure, electrolyte degradation at the carbon interface, and high tortuosity within the sulfur cathode composite.⁴⁴

### No Admission of Prior Art

The discussion in this section is intended to provide background information related to the present disclosure and does not constitute an admission of prior art.

### SUMMARY

### Composite Cathode and All Solid-State Battery

The present disclosure provides a highly reversible and highly ionically/electronically conductive cathode made of a composite material and all solid-state batteries using such a cathode, with excellent electrochemical performance, leveraging sulfide solid electrolytes which serves as an ionic conductor, redox mediator, and active material, enabling promising cycling performance at high areal capacities and at room temperature. The composite cathode provided herein is highly reversible, achieving areal capacities up to 10 mAh cm² and cycling stabilities, 90% retention after 500 cycles, with zero liquid electrolyte while under ambient conditions. Moreover, the micron scale (<10 μm) cathode particles realize high utilization without compromising stability.

### Single-Step Milling

The present disclosure also provides a scalable single step milling process to make the composite cathode material provided herein. The single step milling process facilitates homogenous distribution, inducing lithium phosphorous sulfide conversion and intimate solid-solid contact, resulting in enhanced electrochemical properties and kinetics of the cathode provided herein. The improved solid-solid contact activates the redox active behavior of the halogenated lithium phosphorous sulfide (LPS-X) solid electrolyte, contributing capacity like an active material and facilitating enhanced cycling stability at high rates. The ball-milling also reduces the particle sizes, creating more surface areas.

### Single-step Ball-milling Improving Li₂S Cathode Performance

Li₂S active material exhibits high activation barrier to oxidize to sulfur. According to the present disclosure, Li₂S, LPS-X (such as LPSCl), and carbon are ball-milled together to activate Li₂S. It has been discovered that the ball-milling not only activates Li₂S but also results in LPS-X (such as LPSCl) losing its crystal peaks in XRD analysis after the ball-milling, which was unexpected and surprising. The XRD data shows that LPSCl lost at least some of its crystallinity and may even have lost all its crystallinity after ball-milling. The single-step ball-milling process creates a highly distributed (ionic and electronic network) with increased triple phase boundaries sites for the Li₂S material to be oxidized, which retains ionic conductivity of the Li₂S cathode, contributes to all the improvement in the electrode active material utilization and performance of the Li₂S cathode, and creates favorable electrochemical properties the Li₂S cathode.

### Method of Making Electrode Composite Material

One aspect of the present disclosure provides a method of making an electrode composite material. The method comprises providing in a ball-milling container a mixture that comprises Li₂S particles containing a Li₂S compound, carbon particles, and halogenated lithium phosphorous sulfide (LPS-X) particles containing an LPS-X compound, wherein X is selected from the group consisting of F, Cl, Br, I, and combinations thereof, wherein the LPS-X particles have crystallinity which can be confirmed with XRD of the LPS-X particles or the mixture showing XRD peaks indicative of crystalline LPS-X, wherein the mixture does not comprise lithium phosphorous sulfide (LPS) particles made of an LPS compound. The method further comprises ball-milling the mixture in the ball-milling container to provide a ball-milled composite material such that at least part of the LPS-X compound contained in at least part of the LPS-X particles is converted to the LPS compound and further such that XRD of the ball-milled composite material shows none of the XRD peaks indicative of crystalline LPS-X. In some embodiments, XRD of the ball-milled composite material does not show XRD peak (211) at 2θ of about 13.7°, which indicates crystallinity of the LPS compound.

### Solid Electrolyte (SSE) Particles

In some embodiments, the ball-milled composite material comprises solid electrolyte (SSE) particles, wherein the SSE particles comprise first particles containing solely the LPS-X compound, second particles containing solely the LPS compound, and third particles containing both the LPS and LPS-X compounds. In some embodiments, the ball-milled composite material comprises solid electrolyte (SSE) particles, wherein at least part of the SSE particles contains both the LPS and LPS-X compounds.

Mixture being Ball-Milled

In some embodiments, the mixture consists essentially of the Li₂S particles, the LPS-X particles, and the carbon particles. In some embodiments, the mixture consists of the Li₂S particles, the LPS-X particles, and the carbon particles. In some embodiments, the mixture prior to the ball-milling comprises about 20% to about 40% by weight of the Li₂S particles based on a total weight of the mixture; and about 15% to about 20% by weight of the carbon particles based on the total weight of the mixture.

### Li₂S Particles

In some embodiments, the Li₂S particles are milled prior to the ball-milling of the mixture. In some embodiments, the milling of the Li₂S particles is conducted at about 300-500 RPM for about 10-20 hours. In some embodiments, the Li₂S particles prior to the milling have particle sizes in a range of about 500 nm to about 50 μm. In some embodiments, the Li₂S particles after the milling have particle sizes in a range of about 250 nm to about 25 μm. In some embodiments, the Li₂S particles after the ball-milling of the mixture have particle sizes in a range of about 100 nm to about 1 μm.

### Carbon Particles

In some embodiments, the carbon particles comprise one selected from the group consisting of acetylene black (AB) carbon, vapor grown carbon fiber (VGCF), carbon nanotube (CNT), Ketjen black (KB) carbon, and combinations thereof. In some embodiments, the carbon particles have a BET specific surface area in a range of about 20 m²g⁻¹ to about 1000 m²g⁻¹. In some embodiments, the carbon particles comprise AB carbon. In some embodiments, the carbon particles have a BET specific surface area of about 70 m²g⁻¹.

### Conversion

In some embodiments, the ball-milling converts about 30 wt % to about 70 wt % of the LPS-X particles to the LPS particles. In some embodiments, the ball-milling converts about 50 wt % of the LPS-X particles to the LPS particles. In some embodiments, the LPS particles comprises Li₃PS₄.

### Ball-Milling

In some embodiments, the ball-milling of the mixture is conducted at about 300 to about 550 RPM for about 1 minute to about 20 hours. In some embodiments, the ball-milling of the mixture is conducted at about 500 RPM for about 1 hour.

### Method of Making Electrode Composite Material—Another Aspect

Another aspect of the present disclosure provides another method of making an electrode composite material. The method comprises providing in a ball-milling container a mixture that comprises Li₂S particles, carbon particles, and chlorinated lithium phosphorous sulfide (LPSCl) particles containing an LPSCl compound, wherein the LPSCl particles have crystallinity which can be confirmed with XRD of the LPSCl particles or the mixture showing XRD peaks (111) at 2θ of about 7.5°, (200) at 2θ of about 8°, (220) at 2θ of about 12°, (311) at 2θ of about 13.5°, and (222) at 2θ of about 14.5°, wherein the mixture does not comprise lithium phosphorous sulfide (LPS) particles made of an LPS compound. The method further comprises ball-milling the mixture in the ball-milling container to provide a ball-milled composite material such that at least part of the LPSCl compound contained in at least part of the LPSCl particles is converted to the LPS compound and further such that XRD of the ball-milled composite material shows none of the XRD peaks (111) at 2θ of about 7.5°, (200) at 2θ of about 8°, (220) at 2θ of about 12°, (311) at 2θ of about 13.5°, and (222) at 2θ of about 14.5°. In some embodiments, XRD of the ball-milled composite material does not show XRD peak (211) at 2θ of about 13.7°, which indicates crystallinity of the LPS compound.

### Solid Electrolyte (SSE) Particles

In some embodiments, the ball-milled composite material comprises solid electrolyte (SSE) particles, wherein the SSE particles comprise first particles containing solely the LPSCl compound, second particles containing solely the LPS compound, and third particles containing both the LPS and LPSCl compounds. In some embodiments, the ball-milled composite material comprises solid electrolyte (SSE) particles, wherein at least part of the SSE particles contains both the LPS and LPSCl compounds.

Mixture being Ball-Milled

In some embodiments, the mixture consists essentially of the Li₂S particles, the LPSCl particles, and the carbon particles. In some embodiments, the mixture consists of the Li₂S particles, the LPSCl particles, and the carbon particles. In some embodiments, the mixture prior to the ball-milling comprises about 20% to about 40% by weight of the Li₂S particles based on a total weight of the mixture; and about 15% to about 20% by weight of the carbon particles based on the total weight of the mixture.

### Li₂S Particles

In some embodiments, the Li₂S particles are milled prior to the ball-milling of the mixture. In some embodiments, the milling of the Li₂S particles is conducted at about 300-500 RPM for about 10-20 hours. In some embodiments, the Li₂S particles prior to the milling have particle sizes in a range of about 500 nm to about 50 μm. In some embodiments, the Li₂S particles after the milling have particle sizes in a range of about 250 nm to about 25 μm. In some embodiments, the Li₂S particles after the ball-milling of the mixture have particle sizes in a range of about 100 nm to about 1 μm.

### LPSCl Particles

In some embodiments, the LPSCl comprises Li₆PS₅Cl. In some embodiments, the LPSCl particles prior to the ball-milling of the mixture have particle sizes in a range of about 1 μm to about 30 μm.

### Carbon Particles

In some embodiments, the carbon particles comprise one selected from the group consisting of acetylene black (AB) carbon, vapor grown carbon fiber (VGCF), carbon nanotube (CNT), Ketjen black (KB) carbon, and combinations thereof. In some embodiments, the carbon particles have a BET specific surface area in a range of about 20 m²g⁻¹ to about 1000 m²g⁻¹. In some embodiments, the carbon particles comprise AB carbon. In some embodiments, the carbon particles have a BET specific surface area of about 70 m²g⁻¹.

### Conversion

In some embodiments, the ball-milling converts about 30 wt % to about 70 wt % of the LPSCl particles to the LPS particles. In some embodiments, the ball-milling converts about 50 wt % of the LPSCl particles to the LPS particles. In some embodiments, the LPS particles comprises Li₃PS₄.

### Ball-Milling

In some embodiments, the ball-milling of the mixture is conducted at about 300 to about 550 RPM for about 1 minute to about 20 hours. In some embodiments, the ball-milling of the mixture is conducted at about 500 RPM for about 1 hour.

### Parameters

In some embodiments, the mixture prior to the ball-milling comprises about 20% to about 40% by weight of the Li₂S particles based on a total weight of the mixture, and about 15% to about 20% by weight of the carbon particles based on the total weight of the mixture; wherein the carbon particles comprise one selected from the group consisting of acetylene black carbon, VGCF, CNT, Ketjenblack, and combinations thereof; wherein the LPSCl particles prior to the ball-milling have particle sizes in a range of about 1 μm to about 30 μm; wherein the Li₂S particles prior to the ball-milling have particle sizes in a range of about 250 nm to about 25 μm; wherein the ball-milling of the mixture is conducted at about 300 to about 550 RPM for about 1 hour to about 5 hours; and wherein the ball-milling converts about 30 wt % to about 70 wt % of the LPSCl particles to the LPS particles.

### Alternative Parameters

In some embodiments, the mixture prior to the ball-milling comprises about 25% to about 35% by weight of the Li₂S particles based on a total weight of the mixture, and about 18% to about 20% by weight of the carbon particles based on the total weight of the mixture; wherein the carbon particles comprise acetylene black carbon; wherein the ball-milling of the mixture is conducted at about 400-500 RPM for about 1-5 hours; and wherein the ball-milling converts about 40-60 wt % of the LPSCl particles to the LPS particles.

### Method of Preparing Electrode for All-Solid-State Lithium Battery

Another aspect of the present disclosure provides a method of preparing an electrode for an all-solid-state lithium battery, the method comprising: preparing the ball-milled composite material provided herein; and pressing the ball-milled composite material. In some embodiments, the ball-milled composite material is pressed under a pressure of 300-500 MPa.

### Method of Making All-Solid-State Lithium Battery

Yet another aspect of the present disclosure provides a method of making an all-solid-state lithium battery, the method comprising: preparing a cathode electrode provided herein; providing a solid electrolyte layer; and providing an anode electrode such that the solid electrolyte layer is interposed between the cathode electrode and the anode electrode.

### Electrode Composite Material

Yet another aspect of the present disclosure provides an electrode composite material comprising: Li₂S particles containing a Li₂S compound; carbon particles; and solid electrolyte (SSE) particles comprising first particles containing solely a halogenated lithium phosphorous sulfide (LPS-X) compound, second particles containing solely a lithium phosphorous sulfide (LPS) compound, and third particles containing both the LPS and LPS-X compounds, wherein X is selected from the group consisting of F, Cl, Br, I, and combinations thereof, wherein XRD of the electrode composite material shows none of XRD peaks indicative of crystalline LPS-X. In some embodiments, XRD of the electrode composite material does not show XRD peak (211) at 2θ of about 13.7°, which indicates crystallinity of the LPS compound. One example electrode composite material comprises: Li₂S particles containing a Li₂S compound; carbon particles; and solid electrolyte (SSE) particles comprising first particles containing solely a chlorinated lithium phosphorous sulfide (LPSCl) compound, second particles containing solely a lithium phosphorous sulfide (LPS) compound, and third particles containing both the LPS and LPSCl compounds, wherein XRD of the electrode composite material shows none of XRD peaks (111) at 2θ of about 7.5°, (200) at 2θ of about 8°, (220) at 2θ of about 12°, (311) at 2θ of about 13.5°, and (222) at 2θ of about 14.5° indicative of crystalline LPSCl. In some embodiments, XRD of the electrode composite material does not show XRD peak (211) at 2θ of about 13.7°, which indicates crystallinity of the LPS compound.

### Composition of Electrode Composite Material

In some embodiments, the electrode composite material provided herein comprises about 20% to about 40% by weight of the Li₂S particles based on a total weight of the electrode composite material; and about 15% to about 20% by weight of the carbon particles based on the total weight of the electrode composite material. In some embodiments, the Li₂S particles have particle sizes in a range of about 100 nm to about 1 μm. In some embodiments, the carbon particles comprise one selected from the group consisting of acetylene black (AB) carbon, vapor grown carbon fiber (VGCF), carbon nanotube (CNT), Ketjen black (KB) carbon, and combinations thereof.

### Electrode

Another aspect of the present disclosure provides an electrode comprising the electrode composite material provided herein.

### All Solid State Battery

Yet another aspect of the present disclosure provides an all solid state battery comprising: a cathode electrode comprising the electrode composite material provided herein; an anode electrode; and a solid electrolyte layer positioned between the cathode electrode and the anode electrode and configured to enable transport of lithium ions between the cathode and the anode.

### Summary Not Limiting

It is understood that this disclosure is not limited to the examples summarized in this Summary. Various other aspects are described and exemplified herein.

### BRIEF DESCRIPTION OF THE DRAWINGS

FIG. 1A illustrates particles distribution of an example ball-milled composite material according to an embodiment of the present disclosure.

FIG. 1B illustrates an example triple-phase boundary of the particles in FIG. 1A.

FIG. 1C illustrates particles distribution of a hand-mixed material.

FIG. 1D illustrates particles distribution of a two-step ball-milled material.

FIG. 2 is an example of a solid state battery according to an embodiment of the present disclosure.

FIG. 3A is an SEM image of obtained Li₂S particles.

FIG. 3B is an SEM image of milled LPSCl particles.

FIG. 3C is an SEM image of AB carbon.

FIG. 3D is an SEM image of the Li₂S material as received, at a different magnification from that in FIG. 3A.

FIG. 3E is an SEM image of the milled Li₂S material.

FIG. 4 is a diagram of ball-milling according to some embodiments of the present disclosure.

FIG. 5 shows the XRD results of milled Li₂S/LPSCl/C mixture, milled Li₂S/LPSCl mixture, LPSCl, and Li₂S.

FIGS. 6A to 6F showing the synchrotron XAS results of the composite material made in Example 1-1. FIG. 6A is the reference spectra, FIGS. 6B-6D show the XAS of the pristine, charged, and discharged composite material. FIG. 6E is the raw spectra of S k-edge, and FIG. 6F shows the linear combination fitting results.

FIG. 7 is a diagram showing making an all solid state battery according to an embodiment of the present disclosure.

FIG. 8 shows specific capacity measured for the battery of Example 5-4.

FIG. 9 shows specific capacity measured for the battery of Example 5-5.

FIG. 10 shows specific capacity measured for the battery of Example 5-6.

FIG. 11 shows the comparison of the specific capacities of the batteries of Examples 6-4, 6-5, and 6-6.

FIG. 12 shows the specific capacity measured for the battery made in Example 7-3 in repeated cycles.

FIG. 13 shows the specific capacity measured for the battery made in Example 7-4.

FIG. 14 shows the specific capacities measured for batteries with 30, 35, and 40 wt % of Li₂S.

FIG. 15 shows the specific capacities measured for batteries with 50, 60, and 70 wt % of Li₂S.

### EXEMPLIFICATIONS NOT LIMITING

The exemplifications set out herein illustrate certain non-limiting embodiments, in one form, and such exemplifications are not to be construed as limiting the scope of the appended claims in any manner.

### DETAILED DESCRIPTION

### Examples and Embodiments

The presently disclosed subject matter now will be described and discussed in more detail in terms of some specific embodiments and examples with reference to the accompanying drawings, in which some, but not all embodiments of the invention are shown. Like numbers refer to like elements or parts throughout unless otherwise referenced. The presently disclosed subject matter may be embodied in many different forms and should not be construed as limited to the specific embodiments set forth herein. Rather, these embodiments are provided so that this disclosure will satisfy applicable legal requirements. Indeed, many modifications and other embodiments of the presently disclosed subject matter will come to the mind of one skilled in the art to which the presently disclosed subject matter pertains. Therefore, it is to be understood that the presently disclosed subject matter is not to be limited to the specific embodiments disclosed and that modifications and other embodiments are intended to be included within the scope of the appended claims.

### Definitions

### “A,” “An” And “The”

As used herein, the singular form of a word includes the plural, unless the context clearly dictates otherwise. The plural encompasses the singular and vice versa. Thus, the references “a,” “an” and “the” are generally inclusive of the plurals of the respective terms. For example, while the present disclosure has been described in terms of “a” layer, “a” substrate, “a” cell, and the like, more than one of these and other components, including combinations, can be used.

### “About”

The term “about” indicates and encompasses an indicated value and a range above and below that value.

### “Comprise,” “Consisting Essentially Of”, And “Consisting Of”

The words “comprise,” “comprises,” and “comprising” are to be interpreted inclusively rather than exclusively. Likewise, the terms “include,” “including” and “or” should all be construed to be inclusive, unless such a construction is clearly prohibited from the context. A disclosure of an embodiment defined using the term “comprising” is also a disclosure of embodiments “consisting essentially of” and “consisting of” the disclosed components. The phrase “consisting of” excludes any element, step, or ingredient not specified.

### “And/Or”

The term “and/or” used in the context of “X and/or Y” should be interpreted as “X,” “Y,” or “X and Y.”

### “On” And “Over”

As used herein, the terms “on,” “applied on,” “formed on, “deposited on,” “provided on,” and the like mean applied, formed, overlaid, deposited, or provided on in contact with an underlying or overlying surface. On the other hand, the terms “over” “applied over,” “formed over,” “deposited over,” “overlay,” “provided over,” and the like, mean applied, formed, overlaid, deposited, or provided on or over but not necessarily in contact with the surface. For example, a formed layer “applied over” a substrate layer may contact the substrate without an intervening material; however, the same phrase does not preclude the presence of one or more other layers of the same or different composition located between the formed layer and the substrate layer.

### Markush Group

As used herein, the term “combination thereof” included in any Markush-type expression means a combination or mixture of one or more elements selected from the group of elements disclosed in the Markush-type expression, and refers to the presence of one or more elements selected from the group. The term “combinations thereof” includes every possible combination of elements to which the term refers.

### “Between”

As used herein, the expression “between” is inclusive of end points.

### Numerical Ranges

Furthermore, all numerical ranges herein should be understood to include all integers, whole or fractions, within the range. Moreover, any numerical range recited herein is intended to include all sub-ranges subsumed therein, and these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth. When ranges are given, any endpoints of those ranges and/or numbers within those ranges can be combined with the scope of the present disclosure.

### “Including,” “Such As” and “For Example”

As used herein, “including,” “such as,” “for example,” and like terms mean “including/such as/for example but not limited to.”

### Combination of Embodiments

As used herein, the term “example,” particularly when followed by a listing of terms, is merely illustrative, and should not be deemed to be exclusive or comprehensive. Any embodiment disclosed herein can be combined with any other embodiment disclosed herein unless explicitly indicated otherwise.

### Particle Size

As used herein, particle size refers to the mean particle diameter (D₅₀) as measured using microscopy (e.g., optical microscopy, electron microscopy, scanning electron microscopy (SEM), transmission electron microscopy (TEM), atomic force microscopy (AFM), confocal microscopy, X-ray microscopy, cryo-electron microscopy, Raman microscopy, or fluorescence microscopy). The size can be the diameter of spherical particles or the length along the largest dimension of ellipsoidal or otherwise irregularly shaped particles. As used herein, “D₅₀” of particles refers to the diameter at which 50% of the particles have a smaller diameter.

### Lithium Sulfide Cathode

### Electronic and Ionic Insulating Properties of Li₂S

Lithium Sulfide (Li₂S) is a key material used in lithium-sulfur batteries, particularly as a cathode. However, Li₂S has a wide energy bandgap (approximately 3.6 eV), making it a strong electronic insulator. This wide bandgap limits the movement of electrons at ambient temperatures, preventing significant electrical conduction. Further, while Li₂S inhibits electron flow, it allows the transport of lithium ions (Li⁺), which is crucial for its performance in battery applications. However, its ionic conductivity is relatively low compared to other solid-state materials.

### Volume Change

Volume change in lithium-sulfur batteries is a critical challenge that impacts both the performance and durability of the battery. This effect arises from significant changes in volume during charging and discharging processes as Li₂S is converted into sulfur and vice versa. During charging, Li₂S reverts to sulfur, causing volume contraction. In contrast, during discharge, sulfur reacts with lithium ions to form Li₂S, resulting in considerable volume expansion sulfur can increase its volume by up to 80%.

### Mechanical Strain

The cycling between expansion and contraction leads to recurring stress on the battery components. The drastic volume changes between sulfur and Li₂S cause mechanical strain on the cathode. Over time, this stress can crack or damage the electrode material, leading to the loss of active sulfur and a decline in battery capacity. The mechanical strain can also cause sulfur to separate from the conductive network, further reducing the battery's overall performance.

### Instability in the Cathode Structure

Moreover, the repeated volume shifts introduce instability in the cathode structure, which interrupts the necessary paths for electron and lithium-ion flow. This disruption of conductive channels diminishes the battery's efficiency and reduces its lifespan. Thus, volume change in Li—S batteries is a significant barrier to long-term performance, as the constant swelling and shrinking of sulfur/Li₂S lead to structural damage and efficiency loss.

### Polysulfide Dissolution

Polysulfide dissolution is a major issue in lithium-sulfur batteries negatively affecting the battery's performance and lifespan, mainly originating from the instability of the liquid electrolyte with the polysulfide species, where sulfur-based compounds dissolve into the electrolyte during battery operation. Specifically, during the discharge process, sulfur (S₈) is reduced to form long-chain polysulfides (Li₂S₈, Li₂S₆, etc.), which are soluble in most liquid electrolytes used in lithium-sulfur batteries. These dissolved polysulfides can migrate between the anode and cathode. Over time, they are reduced further to shorter-chain polysulfides (Li₂S₄, Li₂S₂, Li₂S) or fully converted into solid lithium sulfide (Li₂S).

### Irreversible Mass and Capacity Loss

However, this polysulfide migration causes some of these sulfur compounds to shuttle to the lithium anode, where they can be reduced and re-oxidized in a repeated cycle, resulting in the so-called “shuttle effect.” This process results in irreversible mass and capacity loss upon cycling. Polysulfides that dissolve and migrate away from the cathode are no longer available for electrochemical reactions, leading to a gradual loss of active sulfur and a decrease in the battery's capacity.

### Unwanted Side Reactions

Moreover, the polysulfides that reach the anode can react with the lithium metal, forming passivation layers and consuming lithium in unwanted side reactions, which reduces the availability of lithium ions and lowers the battery's overall efficiency. Further, the continuous movement of polysulfides between electrodes contributes to poor coulombic efficiency and limits the number of charge-discharge cycles the battery can undergo before it degrades.

### Electrolyte Degradation at the Carbon Interface

In lithium-sulfur batteries, carbon materials are often used to improve the conductivity of sulfur and Li₂S, as sulfur and Li₂S are non-conductive. However, during battery operation, especially under high voltage and cycling conditions, the electrolyte can break down at the surface of the carbon interface. This degradation is particularly pronounced when polysulfides, which form during the charge-discharge process, come into contact with the carbon material. The reactive nature of these intermediate sulfur species can accelerate electrolyte decomposition. This electrolyte degradation presents a critical challenge for maintaining battery performance and longevity.

### Insulating Byproducts

Further, the breakdown of the electrolyte at the carbon surface can lead to the formation of insulating byproducts, such as solid layers that accumulate at the interface. These byproducts, often composed of lithium salts or other reaction residues, can block ion pathways, reducing the efficiency of lithium-ion transport. As a result, the active surface area of the carbon is diminished, limiting the battery's overall capacity and reducing the ability of sulfur to react efficiently during cycling.

### Loss of Conductivity

Furthermore, electrolyte degradation can also compromise the conductive network established by the carbon matrix. Over time, as the electrolyte decomposes and forms insulating layers, the connection between sulfur and carbon weakens. This loss of conductivity leads to increased internal resistance within the battery, which negatively impacts both the power output and energy efficiency of the battery, making it less suitable for high-performance applications. Additionally, as the electrolyte continues to degrade at the carbon interface, the long-term stability of the battery becomes compromised. With each charge-discharge cycle, the accumulation of degradation products and the weakening of the conductive network result in rapid capacity fading and shorter battery life.

### High Tortuosity

The issue of high tortuosity in the Li₂S cathode of lithium-sulfur batteries represents a significant obstacle to their performance. Tortuosity refers to the complex, winding paths that ions must follow through the porous structure of the cathode. In the context of lithium-sulfur batteries, high tortuosity can severely limit the efficient movement of lithium ions and electrons, leading to multiple performance-related problems.

### Slowed Ion Transport

In lithium-sulfur batteries, lithium ions need to move efficiently through the Li₂S cathode during the charge and discharge cycles. When the cathode's internal structure is highly tortuous, these ions must navigate through long, indirect pathways. This increased diffusion distance slows down ion transport, resulting in sluggish charge/discharge kinetics and poor power delivery.

### Increased Internal Resistance

Furthermore, the difficulty in transporting ions and electrons through a highly tortuous structure contributes to increased internal resistance. As the electrons and ions take longer paths to complete reactions, the battery experiences higher polarization. This means that more energy is required to drive the electrochemical processes, leading to reduced efficiency and lower energy output during operation.

### Uneven Strain and Degradation

High tortuosity can also cause uneven strain and degradation within the cathode material. Because the cathode active material utilization is non-uniform, certain regions of the cathode experience higher stress, which can lead to mechanical failure, cracking, and loss of material integrity over time. As these areas degrade, the overall performance of the battery diminishes, shortening its cycle life and limiting the number of effective charge-discharge cycles it can undergo.

### Making Electrode Composite Material

One aspect of the present disclosure provides a method of making an electrode composite material, in which a mixture that comprises Li₂S particles, carbon particles, and lithium phosphorous sulfide chloride (LPSCl) particles containing an LPSCl compound is provided in a ball-milling container. The LPSCl particles have crystallinity which can be confirmed with XRD of the LPSCl particles or the mixture showing XRD peaks (111) at 2θ of about 7.5°, (200) at 2θ of about 8°, (220) at 2θ of about 12°, (311) at 2θ of about 13.5°, and (222) at 2θ of about 14.5°. The mixture does not comprise lithium phosphorous sulfide (LPS) particles made of an LPS compound. Then, the mixture is ball-milled in the ball-milling container to provide a ball-milled composite material. At least part of the LPSCl compound contained in at least part of the LPSCl particles is converted to the LPS compound.

### Lithium Phosphorus Sulfur Chloride

LPSCl (Li₆PS₅Cl) is known for its high ionic conductivity, which is a crucial property for a solid electrolyte material. High ionic conductivity allows for the efficient movement of lithium ions within the material, facilitating the charging and discharging processes in solid state batteries. LPSCl also has good chemical and thermal stability, which is important for the long-term performance and safety of solid-state batteries. Stability is particularly crucial in high-temperature and high-voltage applications. Moreover, LPSCl has a wide electrochemical stability window and can withstand a wide range of voltages without undergoing undesirable reactions. This is essential for supporting a variety of cathode and anode materials.

### Mixture Prior to Ball-Milling

In some embodiments, the mixture prior to the ball-milling may consist essentially of the Li₂S particles, the LPSCl particles, and the carbon particles. In some embodiments, the mixture consists of the Li₂S particles, the LPSCl particles, and the carbon particles.

### Solid Electrolyte Particles in Ball-Milled Composite Material

The ball-milled composite material comprises solid electrolyte (SE) particles, wherein the SE particles comprise first particles containing solely the LPSCl compound, second particles containing solely the LPS compound, and third particles containing both the LPS and LPSCl compounds. In some embodiments, the ball-milled composite material comprises solid electrolyte (SE) particles, wherein at least part of the SE particles contains both the LPS and LPSCl compounds.

### Loss of LPSCl Crystallinity

XRD of the ball-milled composite material shows none of the XRD peaks (111) at 2θ of about 7.5°, (200) at 2θ of about 8°, (220) at 2θ of about 12°, (311) at 2θ of about 13.5°, and (222) at 2θ of about 14.5°, which indicates the crystallinity of LPSCl. This indicates that the LPSCL is converted or broken down to other materials during the ball-milling, and thus at least part or all of the crystallinity of LPSCl is lost after the ball-milling.

Other stoichiometries and or substitutions of elements such as F, I, and Br within LPS-X can be used, instead of using only Cl. Using substituted halogen elements as listed above can improve the ionic conductivity or alter the electrochemical stability, which will result in an improvement in the system's electrochemical performance.

Therefore, another aspect of the present disclosure provides a method of making an electrode composite material. Specifically, in a ball-milling container, a mixture that comprises lithium sulfide (Li₂S) particles containing a Li₂S compound, carbon particles, and halogenated lithium phosphorous sulfide (LPS-X) particles containing an LPS-X compound is provided. X is selected from the group consisting of F, Cl, Br, I, and combinations thereof. The LPS-X particles have crystallinity which can be confirmed with XRD of the LPS-X particles or the mixture showing XRD peaks indicative of crystalline LPS-X. The mixture does not comprise lithium phosphorous sulfide (LPS) particles made of an LPS compound. The mixture is ball-milled in the ball-milling container to provide a ball-milled composite material. At least part of the LPS-X compound contained in at least part of the LPS-X particles is converted to the LPS compound.

### Mixture Prior to Ball-Milling

The mixture prior to the ball-milling may consist essentially of the Li₂S particles, the LPS-X particles, and the carbon particles. The mixture prior to the ball-milling may consist of the Li₂S particles, the LPS-X particles, and the carbon particles.

### LPS-X Particles

The LPS-X particles may contain LPSF. The LPS-X particles may contain LPSCl. The LPS-X particles may contain LPSBr. The LPS-X particles may contain LPSI. The LPS-X particles may contain any two or more of LPSF, LPSCl, LPSBr, and LPSI. The LPS-X particles may contain LPSF and LPSCl. The LPS-X particles may contain LPSF and LPSBr. The LPS-X particles may contain LPSF and LPSI. The LPS-X particles may contain LPSCl and LPSBr. The LPS-X particles may contain LPSCl and LPSI. The LPS-X particles may contain LPSBr and LPSI. The LPS-X particles may contain LPSF, LPSCl and LPSBr. The LPS-X particles may contain LPSF, LPSCl and LPSI. The LPS-X particles may contain LPSF, LPSBr and LPSI. The LPS-X particles may contain LPSCl, LPSBr and LPSI. The LPS-X particles may contain LPSF, LPSCl, LPSBr and LPSI.

### Loss of LPS-X Crystallinity

XRD of the ball-milled composite material shows none of the XRD peaks indicative of crystalline LPS-X. This indicates that the LPS-X is converted or broken down to other materials during the ball-milling, and thus at least part or all of the crystallinity of LPSCl is lost after the ball-milling.

### Solid Electrolyte Particles in Ball-Milled Composite Material

The ball-milled composite material comprises solid electrolyte (SE) particles, wherein the SE particles comprise first particles containing solely the LPS-X compound, second particles containing solely the LPS compound, and third particles containing both the LPS and LPS-X compounds. In some embodiments, the ball-milled composite material comprises solid electrolyte (SE) particles, wherein at least part of the SE particles contains both the LPS and LPS-X compounds.

### Poor Crystallinity or Nanocrystalinity Of LPS

In each of the aspects provided herein, XRD of the ball-milled composite material does not show XRD peak (211) at 2θ of about 13.7°, which indicates crystallinity of the LPS compound. This indicates that the LPS in the ball-milled composite material has low crystallinity or nanocrystalinity.

### Milling of Li₂S Particles

The Li₂S particles may be milled prior to being provided to form the mixture that will be subject to the ball-milling. The milling of the Li₂S particles may be one or more of ball-milling, jet-milling, attritor (stirred media)-milling, hammer-milling, roller-milling, planetary-milling, ultrasonic-milling, colloid-milling, pin-milling, and/or any other suitable milling process. It must be noted that the method provided herein works well with “as received” Li₂S also. Reducing the particle size just increases the overall cell capacity and improves the performance.

### Li₂S Particles Milling Speed

The milling of the Li₂S particles may be conducted at a speed of about 300-500 RPM, for example, at or about 300, 310, 320, 330, 340, 350, 360, 370, 380, 390, 400, 410, 420, 430, 440, 450, 460, 470, 480, 490, or 500 RPM. In embodiments, the speed at which the milling of the Li₂S particles is conducted can be within a range formed by selecting any two numbers listed above or by selecting any two numbers in the range of from about 300 RPM to about 500 RPM.

### Li₂S Particles Milling Duration

The milling of the Li₂S particles may be conducted for about 10-20 hours, for example, at or about 10, 11, 12, 13, 14, 15, 16, 17, 18, 19, or 20 hours. In embodiments, this milling can be conducted for a duration within a range formed by selecting any two numbers listed above or by selecting any two numbers in the range of from about 10 hours to about 20 hours.

### Li₂S Particle Size Before Being Milled

The Li₂S particles before being milled may have particle sizes in a range of about 500 nm to about 50 μm. In embodiments, the Li₂S particles before being milled can have an average particle size of at or about any of 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 μm. In embodiments, the Li₂S particle size may be within a range formed by selecting any two numbers listed above or by selecting any two numbers in the range of from about 500 nm to about 50 μm.

### Li₂S Particle Size After Being Milled

The Li₂S particles after being milled but before being ball-milled in the mixture may have particle sizes in a range of about 250 nm to about 25 μm. In embodiments, the Li₂S particles after being milled but before being ball-milled in the mixture can have an average particle size of at or about any of 0.25, 0.3, 0.35, 0.4, 0.45, 0.5, 0.55, 0.6, 0.65, 0.7, 0.75, 0.8, 0.85, 0.9, 0.95, 1, 2, 3, 4, 5, 6, 7, 8, 9, 10, 11, 12, 13, 14, 15, 16, 17, 18, 19, 20, 21, 22, 23, 24, or μm. In embodiments, this Li₂S particle size may be within a range formed by selecting any two numbers listed above or by selecting any two numbers in the range of from about 250 nm to about 25 μm.

### Li₂S Particle Size in the Ball-Milled Composite Material

The Li₂S particles after the ball-milling of the mixture, in the ball-milled composite material, may have particle sizes in a range of about 100 nm to about 1 μm. In embodiments, the Li₂S particles after the ball-milling of the mixture, in the ball-milled composite material, can have an average particle size of at or about any of 0.1, 0.2, 0.3, 0.4, 0.5, 0.6, 0.7, 0.8, 0.9, or 1 am. In embodiments, this Li₂S particle size may be within a range formed by selecting any two numbers listed above or by selecting any two numbers in the range of from about 100 nm to about 1 μm.

### Carbon Particles Type

The carbon particles may include one or more types, such as super P carbon black, ketjenblack carbon, acetylene back carbon, natural graphite, synthetic graphite, expanded graphite, single-walled carbon nanotubes (SWCNTs), multi-walled carbon nanotubes (MWCNTs), graphene, graphene oxide (GO), reduced graphene oxide (rGo), carbon nanofibers (CNFs), carbon nano-onions, mesoporous carbon, carbon quantum dots (CQDs), carbon aerogels, or bio-derived carbon particles. For example, the carbon particles may comprise one selected from the group consisting of acetylene black (AB) carbon, vapor grown carbon fiber (VGCF), carbon nanotube (CNT), Ketjen black (KB) carbon, and combinations thereof. In some embodiments, the carbon particles may comprise AB carbon.

### Carbon Particles Surface Area

The carbon particles may have a BET specific surface area in a range of about 20 m²g⁻¹ to about 1000 m²g⁻¹, for example, at or about 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 m²g⁻¹. In embodiments, the carbon particles may have a BET specific surface area in a range formed by selecting any two numbers listed above or by selecting any two numbers in the range of from about 20 m²g⁻¹ to about 1000 m²g⁻¹. For example, in some embodiments, the carbon particles may have a BET specific surface area of about 70 m²g⁻¹.

### Conversion Rate

The ball-milling may convert about 30 wt % to about 70 wt % of the LPSCl compound to the LPS compound. For example, the weight percentage of the LPSCl compound converted to the LPS compound can be at or about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt %. In embodiments, the weight percentage of the LPSCl compound converted to the LPS compound can be within a range formed by selecting any two numbers listed above or by selecting any two numbers in the range of from about 30 wt % to about 70 wt %. For example, in some embodiment, the ball-milling may convert about 50 wt % of the LPSCl particles to the LPS particles.

The LPS particles may comprise Li₃PS₄.

### Li₂S Particles Weight Percentage

The mixture prior to the ball-milling may comprise about 20% to about 40% by weight of the Li₂S particles based on a total weight of the mixture. For example, the weight percentage of the Li₂S particles based on a total weight of the mixture can be at or about 20, 21, 22, 23, 24, 25, 26, 27, 28, 29, 30, 31, 32, 33, 34, 35, 36, 37, 38, 39, or 40 wt %. In embodiments, the weight percentage of the Li₂S particles based on a total weight of the mixture can be within a range formed by selecting any two numbers listed above or by selecting any two numbers in the range of from about 20 wt % to about 40 wt %.

### Carbon Particles Weight Percentage

The mixture prior to the ball-milling may comprise about 15% to about 20% by weight of the carbon particles based on the total weight of the mixture. For example, the weight percentage of the carbon particles based on a total weight of the mixture can be at or about 15, 16, 17, 18, 19, or 20 wt %. In embodiments, the weight percentage of the carbon particles based on a total weight of the mixture can be within a range formed by selecting any two numbers listed above or by selecting any two numbers in the range of from about 15 wt % to about 20 wt %.

### LPS-X Particle Size

The LPS-X particles may have a volume-based average particle size from, for example, about 0.1 μm to about 50 μm, about 0.1 μm to about 40 μm, about 0.1 μm to about 30 μm, about 0.1 μm to about 20 μm, about 0.1 μm to about 10 μm, about 0.1 μm to about 5 μm, about 0.1 μm to about 1 μm, about 1 μm to about 50 μm, about 1 μm to about 40 μm, about 1 μm to about 30 μm, about 1 μm to about 20 μm, about 1 μm to about 10 μm, about 1 μm to about 5 μm, about m to about 50 μm, about 5 μm to about 40 μm, about 5 μm to about 30 μm, about 5 μm to about 20 μm, about 5 μm to about 10 μm, about 10 μm to about 50 μm, about 10 μm to about 40 μm, about 10 μm to about 30 μm, about 10 μm to about 20 μm, about 20 μm to about 50 μm, about 20 μm to about 40 μm, about 20 μm to about 30 μm, about 20 μm to about 50 μm, about 20 μm to about 40 μm, about 20 μm to about 30 μm, about 30 μm to about 50 μm, about 30 μm to about 40 μm, about 40 μm to about 50 μm, etc, as measured by laser diffraction type particle size distribution measurement. In embodiments, the LPS-X particles can have an average particle size in a range of from about 0.1 μm to about 50 μm, such as about any of 0.1, 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 μm. In embodiments, the LPS-X particle size may be within a range formed by selecting any two numbers listed above or by selecting any two numbers in the range of from about 0.1 μm to about 50 μm.

### Ball-Milling

### Ball Milling Generally

Ball milling is a valuable technique for mixing and preparing materials for solid-state batteries. Ball milling is a mechanical technique widely used to grind powders into fine particles and mix materials in various applications, including the preparation of solid-state battery components. In the context of solid-state batteries, ball milling is often employed to mix and blend the electrode materials, solid electrolytes, and other components. Exemplary ball milling devices may include planetary ball mills, attritor mills, and vibratory ball mills. These devices typically consist of a rotating or vibrating chamber containing grinding balls made of materials such as steel, ceramic, or zirconia.

### Homogeneous Mixing

Ball milling is effective in achieving a homogeneous mixture of different powders. This is crucial for ensuring uniform distribution of components in the electrode materials and solid electrolytes, which, in turn, impacts the overall performance of the battery.

### Reducing Particle Size

Ball milling can reduce the particle size of the materials involved, leading to increased surface area and improved reactivity. Here, the ball-milling of the mixture reduces particle sizes in the mixture, creating more surface areas compared to those in the mixture prior to the ball-milling of the mixture. Smaller particle sizes can enhance the kinetics of electrochemical reactions, contributing to better battery performance. The micron scale particles (<10 μm) in the composite material provided herein realize high utilization without compromising stability.

### Enhanced Electrode-Electrolyte Interface

Ball milling can facilitate the formation of a well-defined interface between the electrode and solid electrolyte. This is important for promoting efficient ion transport and minimizing interfacial resistance within the solid-state battery.

### Promoting Solid-State Reactions

Ball milling can induce solid-state reactions between different components, promoting the formation of desired phases and structures in the materials. This is particularly relevant for the synthesis of composite electrode materials or preparation of the composite electrolyte materials provided herein. Here, the ball-milling provides energy that converts or break down the LPS-X to LPS.

### Shortening Lithium Ion Diffusion Length

Here, after the ball-milling of the mixture, the Li₂S particles have closer contact with the SSE particles in the ball-milled composite material, compared to that between the Li₂S particles and the LPS-X particles prior to the ball-milling of the mixture, and this closer contact shortens the lithium ion diffusion length in the electrode composite material compared to that in the mixture without the ball-milling.

### Optimizing Conductivity

Ball milling can be used to optimize the conductivity of electrode materials by ensuring a good distribution of conductive additives, such as carbon or metal nanoparticles, within the composite; or the additive materials, within the solid electrolyte, as provided herein.

### Controlling Morphology

The milling process can also influence the morphology of the materials, including particle shape, size, and distribution. Controlling these aspects is important for achieving the desired electrochemical properties and overall performance of the solid-state battery.

### Triple Phase Boundary Site

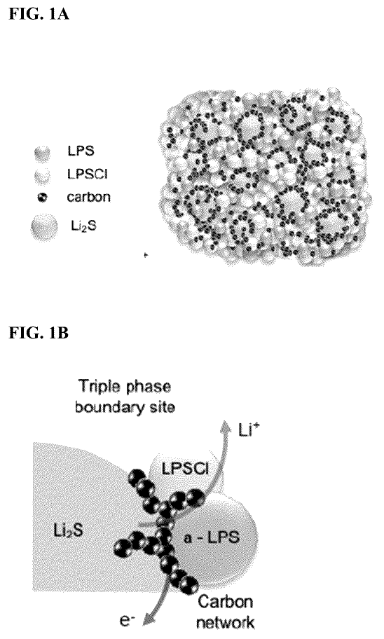

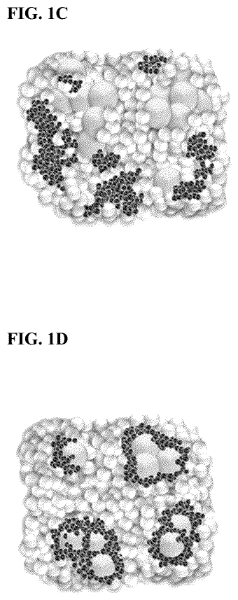

Here, because of the formation of LPS in the ball-milled composite material, the ball-milling increases sites of triple phase boundaries among the Li₂S particles, the remaining LPS-X particles, and the newly formed LPS particles or particles containing the newly formed LPS at surfaces of the Li₂S particles in the mixture for Li₂S oxidation to sulfur, facilitating enhanced lithium ion transport in the electrode composite material. As shown in FIG. 1A, in an example ball-milled composite material containing Li₂S, LPS, LPSCl, and carbon particles, the one-step mall-milling achieved excellent distribution of the Li₂S, LPS, and LPSCl ionic particles, creating a composite architecture that facilitates good ionic and electronic transport and sufficient triple phase boundary contact points, required for effective (de)lithiation. These ionic particles form triple-phase boundaries where they contact each other, and the carbon particles are distributed at these triple-phase boundaries contacting each of these particles, as shown in FIG. 1B. The conductive carbon particles form a conductive carbon network throughout the ball-milled composite material, providing conductivity and facilitating the lithium ion transport throughout the material. Moreover, LPS is the most stable electrolyte with α-sulfur, forming interfacial 2D channels that lowers activation barriers for lithium diffusion, and the high oxidation tendency of LPSCl can then help overcome the sluggish kinetics of charging Li₂S to sulfur.

### Comparing One-Step Ball-Milling and Hand-Mixing

In contrast, as shown in FIG. 1C, in an example composite material prepared by hand-mixing Li₂S, LPSCl, and carbon particles, there is no LPS formed, and the Li₂S, LPSCl, and carbon particles are not evenly distributed as those in FIG. 1A. These particles form isolated regions of Li₂S, LPSCl, and carbon particles by themselves, forming poor ionic and electronic network in the mixed material with low active surface area, compared to the composite material prepared by the one-step ball-milling of the methods provided herein. The hand-mixing has low energy, which is not enough to facilitate the conversion of LPSCl to LPS.

### Comparing One-Step Ball-Milling and Two-Step Ball-Milling

On the other hand, although two-step ball-milling may have similar energy to that of the one-step ball-milling, it also creates isolated regions with Li₂S clusters and carbon particles surrounding the Li₂S clusters. Thus, the two-step ball-milling also forms poor ionic and electronic network in the resultant material with low active surface area.

### Improved Solid-Solid Contact

The one-step ball-milling facilitates homogenous distribution, inducing sulfur amorphization and intimate cathode/SSE solid-solid contact, responsible for the enhanced electrochemical properties and kinetics of the composite material, providing a reversible and highly ionically/electronically conductive cathode composite material. The improved solid-solid contact activates the redox active behavior of the argyrodite LPSCl electrolyte, contributing capacity like an active material and enabling a practical all solid-state lithium sulfur battery with high utilization, areal capacities, and good cycling stability.

### Energy Considerations

Ball milling is an energy-intensive process, and the duration and speed of milling need to be carefully controlled to avoid excessive heating, which could lead to undesired reactions or damage to the materials.

### Ball-Milling Speed

The ball-milling of the mixture may be conducted at a speed of about 300 to about 550 RPM, for example, at or about 300, 310, 320, 330, 340, 350, 360, 370, 380, 390, 400, 410, 420, 430, 440, 450, 460, 470, 480, 490, 500, 510, 520, 530, 540, or 550 RPM. In embodiments, the speed at which the ball-milling of the mixture is conducted can be within a range formed by selecting any two numbers listed above or by selecting any two numbers in the range of from about 300 RPM to about 550 RPM. For example, in some embodiments, the ball-milling of the mixture may be conducted at about 500 RPM.

### Ball-Milling Duration

The ball-milling of the mixture may be conducted for about 1 minute to about 20 hours, for example, at or about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59 minutes, 1, 2, 3, 4, 5, 6, 7, 8, 9, 10, 11, 12, 13, 14, 15, 16, 17, 18, 19, or 20 hours. In embodiments, the ball-milling can be conducted for a duration within a range formed by selecting any two numbers listed above or by selecting any two numbers in the range of from about 1 minute to about 20 hours. For example, in some embodiments, the ball-milling of the mixture may be conducted for about 1 hour.

### Ball-Milling Conditions—Example

In some embodiments, the mixture prior to the ball-milling comprises about 20% to about 40% by weight of the Li₂S particles based on a total weight of the mixture, and about 15% to about 20% by weight of the carbon particles based on the total weight of the mixture; the carbon particles comprise one selected from the group consisting of acetylene black carbon, VGCF, CNT, Ketjenblack, and combinations thereof; the LPS-X particles prior to the ball-milling have particle sizes in a range of about 1 μm to about 30 μm; the Li₂S particles prior to the ball-milling have particle sizes in a range of about 250 nm to about 25 μm; the ball-milling of the mixture is conducted at about 300 to about 550 RPM for about 1 hour to about 5 hours; and the ball-milling converts about 30 wt % to about 70 wt % of the LPS-X particles to the LPS particles.

### Ball-Milling Conditions—Another Example

For example, when LPS-X comprises LPSCl, the mixture prior to the ball-milling comprises about 20% to about 40% by weight of the Li₂S particles based on a total weight of the mixture, and about 15% to about 20% by weight of the carbon particles based on the total weight of the mixture; the carbon particles comprise one selected from the group consisting of acetylene black carbon, VGCF, CNT, Ketjenblack, and combinations thereof; the LPSCl particles prior to the ball-milling have particle sizes in a range of about 1 μm to about 30 μm; the Li₂S particles prior to the ball-milling have particle sizes in a range of about 250 nm to about 25 μm; the ball-milling of the mixture is conducted at about 300 to about 550 RPM for about 1 hour to about 5 hours; and the ball-milling converts about 30 wt % to about 70 wt % of the LPSCl particles to the LPS particles.

### Ball-Milling Conditions—Yet Another Example

In some embodiments, the mixture prior to the ball-milling comprises about 25% to about 35% by weight of the Li₂S particles based on a total weight of the mixture, and about 18% to about 20% by weight of the carbon particles based on the total weight of the mixture; wherein the carbon particles comprise acetylene black carbon; the ball-milling of the mixture is conducted at about 400-500 RPM for about 1-5 hours; and the ball-milling converts about 40-60 wt % of the LPS-X particles to the LPS particles.

### Ball-Milling Conditions—Additional Example

For example, when LPS-X comprises LPSCl, the mixture prior to the ball-milling comprises about 25% to about 35% by weight of the Li₂S particles based on a total weight of the mixture, and about 18% to about 20% by weight of the carbon particles based on the total weight of the mixture; wherein the carbon particles comprise acetylene black carbon; the ball-milling of the mixture is conducted at about 400-500 RPM for about 1-5 hours; and the ball-milling converts about 40-60 wt % of the LPSCl particles to the LPS particles.

### Electrode Composite Material

Another aspect of the present disclosure provides an electrode composite material comprising: Li₂S particles containing a Li₂S compound; carbon particles; and solid electrolyte (SE) particles comprising first particles containing solely a halogenated lithium phosphorous sulfide (LPS-X) compound, second particles containing solely a lithium phosphorous sulfide (LPS) compound, and third particles containing both the LPS and LPS-X compounds, wherein wherein X is selected from the group consisting of F, Cl, Br, I, and combinations thereof, and wherein XRD of the electrode composite material shows none of XRD peaks indicative of crystalline LPS-X.

Further, XRD of the electrode composite material does not show XRD peak (211) at 2θ of about 13.7°, which indicates crystallinity of the LPS compound.

The LPS-X may be LPSF. The LPS-X may be LPSCl. The LPS-X may be LPSBr. The LPS-X may be LPSI. The LPS-X may comprise any two or more of LPSF, LPSCl, LPSBr, and LPSI. The LPS-X may comprise LPSF and LPSCl. The LPS-X may comprise LPSF and LPSBr. The LPS-X may comprise LPSF and LPSI. The LPS-X may comprise LPSCl and LPSBr. The LPS-X may comprise LPSCl and LPSI. The LPS-X may comprise LPSBr and LPSI. The LPS-X may comprise LPSF, LPSCl and LPSBr. The LPS-X may comprise LPSF, LPSCl and LPSI. The LPS-X may comprise LPSF, LPSBr and LPSI. The LPS-X may comprise LPSCl, LPSBr and LPSI. The LPS-X may comprise LPSF, LPSCl, LPSBr and LPSI.

For example, when the LPS-X comprises LPSCl, the electrode composite material comprises: Li₂S particles containing a Li₂S compound; carbon particles; and solid electrolyte (SE) particles comprising first particles containing solely a lithium phosphorous sulfide chloride (LPSCl) compound, second particles containing solely a lithium phosphorous sulfide (LPS) compound, and third particles containing both the LPS and LPSCl compounds, wherein XRD of the electrode composite material shows none of XRD peaks (111) at 2θ of about 7.5°, (200) at 2θ of about 8°, (220) at 2θ of about 12°, (311) at 2θ of about 13.5°, and (222) at 2θ of about 14.5° indicative of crystalline LPSCl.

When the LPS-X comprises LPSF, the electrode composite material comprises: Li₂S particles containing a Li₂S compound; carbon particles; and solid electrolyte (SE) particles comprising first particles containing solely a lithium phosphorous sulfide fluoride (Li₉PS₆F, or “LPSF”) compound, second particles containing solely a lithium phosphorous sulfide (LPS) compound, and third particles containing both the LPS and LPSF compounds, wherein XRD of the electrode composite material shows none of XRD peaks indicative of crystalline LPSF. The ball-milling reduces the electrolyte into its decomposition products as shown with LPSCl. For this case, LPSF is converted to Li₂S, LPS, and LiF.

When the LPS-X comprises LPSBr, the electrode composite material comprises: Li₂S particles containing a Li₂S compound; carbon particles; and solid electrolyte (SE) particles comprising first particles containing solely a lithium phosphorous sulfide bromide (Li₁₀P₃S₁₂Br, or “LPSBr”) compound, second particles containing solely a lithium phosphorous sulfide (LPS) compound, and third particles containing both the LPS and LPSBr compounds, wherein XRD of the electrode composite material shows none of XRD peaks indicative of crystalline LPSBr. The ball-milling reduces the electrolyte into its decomposition products as shown with LPSCl. For this case, LPSBr is converted to Li₂S, LPS, and LiBr.

When the LPS-X comprises LPSI, the electrode composite material comprises: Li₂S particles containing a Li₂S compound; carbon particles; and solid electrolyte (SE) particles comprising first particles containing solely a lithium phosphorous sulfide iodide (Li₉PS₇I, or “LPSI”) compound, second particles containing solely a lithium phosphorous sulfide (LPS) compound, and third particles containing both the LPS and LPSI compounds, wherein XRD of the electrode composite material shows none of XRD peaks indicative of crystalline LPSI. The ball-milling reduces the electrolyte into its decomposition products as shown with LPSCl. For this case, LPSI is converted to Li₂S, LPS, and LiI.

### LPS-X Particle Size

The particles containing solely the LPS-X may have a volume-based average particle sizes in a range of from about 0.1 μm to about 50 μm, for example, at or about 0.1, 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 μm. In embodiments, these particles may have an average particle size within a range formed by selecting any two numbers listed above or by selecting any two numbers in the range of from about 0.1 μm to about 50 μm.

### LPS Particle Size

The particles containing solely the LPS may have a volume-based average particle sizes in a range of from about 0.1 μm to about 50 μm, for example, at or about 0.1, 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 μm. In embodiments, these particles may have an average particle size within a range formed by selecting any two numbers listed above or by selecting any two numbers in the range of from about 0.1 μm to about 50 μm.

### LPS/LPS-X Particle Size

The particles containing both the LPS and LPS-X may have a volume-based average particle sizes in a range of from about 0.1 μm to about 50 μm, for example, at or about 0.1, 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 μm. In embodiments, these particles may have an average particle size within a range formed by selecting any two numbers listed above or by selecting any two numbers in the range of from about 0.1 μm to about 50 μm.

### Carbon Particles Type

The carbon particles may include one or more types, such as super P carbon black, ketjenblack carbon, acetylene back carbon, natural graphite, synthetic graphite, expanded graphite, single-walled carbon nanotubes (SWCNTs), multi-walled carbon nanotubes (MWCNTs), graphene, graphene oxide (GO), reduced graphene oxide (rGo), carbon nanofibers (CNFs), carbon nano-onions, mesoporous carbon, carbon quantum dots (CQDs), carbon aerogels, or bio-derived carbon particles. For example, the carbon particles may comprise one selected from the group consisting of acetylene black (AB) carbon, vapor grown carbon fiber (VGCF), carbon nanotube (CNT), Ketjen black (KB) carbon, and combinations thereof. In some embodiments, the carbon particles may comprise AB carbon.

### Carbon Particles Surface Area

The carbon particles may have a BET specific surface area in a range of about 20 m²g⁻¹ to about 1000 m²g⁻¹, for example, at or about 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 m²g⁻¹. In embodiments, the carbon particles may have a BET specific surface area in a range formed by selecting any two numbers listed above or by selecting any two numbers in the range of from about 20 m²g⁻¹ to about 1000 m²g⁻¹. For example, in some embodiments, the carbon particles may have a BET specific surface area of about 70 m²g⁻¹.

The LPS particles may comprise Li₃PS₄.

### Li₂S Particles Weight Percentage

The electrode composite material may comprise about 20% to about 40% by weight of the Li₂S particles based on a total weight of the electrode composite material. For example, the weight percentage of the Li₂S particles based on a total weight of the electrode composite material can be at or about 20, 21, 22, 23, 24, 25, 26, 27, 28, 29, 30, 31, 32, 33, 34, 35, 36, 37, 38, 39, or 40 wt %. In embodiments, the weight percentage of the Li₂S particles based on a total weight of the electrode composite material can be within a range formed by selecting any two numbers listed above or by selecting any two numbers in the range of from about 20 wt % to about 40 wt %.

### Carbon Particles Weight Percentage

The electrode composite material may comprise about 15% to about 20% by weight of the carbon particles based on the total weight of the electrode composite material. For example, the weight percentage of the carbon particles based on a total weight of the electrode composite material can be at or about 15, 16, 17, 18, 19, or 20 wt %. In embodiments, the weight percentage of the carbon particles based on a total weight of the electrode composite material can be within a range formed by selecting any two numbers listed above or by selecting any two numbers in the range of from about 15 wt % to about 20 wt %.

### Li₂S Particle Size

The Li₂S particles may have particle sizes in a range of about 100 nm to about 1 μm. In embodiments, the Li₂S particles may have an average particle size of at or about any of 0.1, 0.2, 0.3, 0.4, 0.5, 0.6, 0.7, 0.8, 0.9, or 1 μm. In embodiments, this Li₂S particle size may be within a range formed by selecting any two numbers listed above or by selecting any two numbers in the range of from about 100 nm to about 1 μm.

### Making Electrode and Battery and Electrode and Battery Made Thereof

### Making Electrode

One aspect of the present disclosure provides a method of making an electrode for an all-solid-state battery by pressing the electrode composite material provided herein under a pressure from about 300 MPa to about 500 MPa.

### Electrode Composite Material

According to one aspect of the present disclosure provided herein, the composite material may comprise Li₂S particles containing a Li₂S compound; carbon particles; and solid electrolyte (SE) particles comprising first particles containing solely a halogenated lithium phosphorous sulfide (LPS-X) compound, second particles containing solely a lithium phosphorous sulfide (LPS) compound, and third particles containing both the LPS and LPS-X compounds, wherein X is selected from the group consisting of F, Cl, Br, I, and combinations thereof, wherein XRD of the electrode composite material shows none of XRD peaks indicative of crystalline LPS-X. Further, XRD of the electrode composite material does not show XRD peak (211) at 2θ of about 13.7°, which indicates crystallinity of the LPS compound.

Electrode Composite Material Made from LPSCl

For example, when the LPS-X comprises LPSCl, the electrode composite material comprises: Li₂S particles containing a Li₂S compound; carbon particles; and solid electrolyte (SE) particles comprising first particles containing solely a lithium phosphorous sulfide chloride (LPSCl) compound, second particles containing solely a lithium phosphorous sulfide (LPS) compound, and third particles containing both the LPS and LPSCl compounds, wherein XRD of the electrode composite material shows none of XRD peaks (111) at 2θ of about 7.5°, (200) at 2θ of about 8°, (220) at 2θ of about 12°, (311) at 2θ of about 13.5°, and (222) at 2θ of about 14.5° indicative of crystalline LPSCL. Further, XRD of the electrode composite material does not show XRD peak (211) at 2θ of about 13.7°, which indicates crystallinity of the LPS compound.

Electrode Composite Material Made from LPSF

When the LPS-X comprises LPSF, the electrode composite material comprises: Li₂S particles containing a Li₂S compound; carbon particles; and solid electrolyte (SE) particles comprising first particles containing solely a lithium phosphorous sulfide fluoride (Li₉PS₆F, or “LPSF”) compound, second particles containing solely a lithium phosphorous sulfide (LPS) compound, and third particles containing both the LPS and LPSF compounds, wherein XRD of the electrode composite material shows none of XRD peaks indicative of crystalline LPSF. Further, XRD of the electrode composite material does not show XRD peak (211) at 2θ of about 13.7°, which indicates crystallinity of the LPS compound.

Electrode Composite Material Made from LPSBr

When the LPS-X comprises LPSBr, the electrode composite material comprises: Li₂S particles containing a Li₂S compound; carbon particles; and solid electrolyte (SE) particles comprising first particles containing solely a lithium phosphorous sulfide bromide (Li₁₀P₃S₁₂Br, or “LPSBr”) compound, second particles containing solely a lithium phosphorous sulfide (LPS) compound, and third particles containing both the LPS and LPSBr compounds, wherein XRD of the electrode composite material shows none of XRD peaks indicative of crystalline LPSBr. Further, XRD of the electrode composite material does not show XRD peak (211) at 2θ of about 13.7°, which indicates crystallinity of the LPS compound.

Electrode Composite Material Made from LPSI

When the LPS-X comprises LPSI, the electrode composite material comprises: Li₂S particles containing a Li₂S compound; carbon particles; and solid electrolyte (SE) particles comprising first particles containing solely a lithium phosphorous sulfide iodide (Li₉PS₇I, or “LPSI”) compound, second particles containing solely a lithium phosphorous sulfide (LPS) compound, and third particles containing both the LPS and LPSI compounds, wherein XRD of the electrode composite material shows none of XRD peaks indicative of crystalline LPSI. Further, XRD of the electrode composite material does not show XRD peak (211) at 2θ of about 13.7°, which indicates crystallinity of the LPS compound.

### Other Features of Electrode Composite Material

Other features of the electrode composite material are described in other parts of the present disclosure.

### Pressing Pressure

The electrode composite material provided herein is pressed under a pressure from about 300 MPa to about 500 MPa, for example, at or about 300, 310, 320, 330, 340, 350, 360, 370, 380, 390, 400, 410, 420, 430, 440, 450, 460, 470, 480, 490, or 500 MPa. The pressure at which the electrode composite material is pressed to make the electrode can be within a range formed by selecting any two numbers listed above or by selecting any two numbers in the range of from about 300 MPa to about 500 MPa.

### Electrode

Another aspect of the present disclosure provides the electrode made by the method of making the electrode provided herein. The electrode may be a cathode electrode.

Making all-Solid-State Lithium Battery

One aspect of the present disclosure provides a method of making an all-solid-state lithium battery, wherein a cathode electrode is prepared as provided herein, a solid electrode layer is provided, and then an anode electrode is provided, such that the solid electrolyte layer is interposed between the cathode electrode and the anode electrode.

### All-Solid-State Battery

Another aspect of the present disclosure provides the all-solid-state battery made by the method of making the all-solid-state battery provided herein. The all-solid-state battery may comprise a cathode electrode provided herein; an anode electrode; and a solid electrolyte layer positioned between the cathode electrode and the anode electrode and configured to enable transport of lithium ions between the cathode electrode and the anode electrode

### Solid Electrolyte Layer Generally

The solid electrolyte layer provided herein is suitable for and enables lithium ion diffusion between the cathode electrode and the anode electrode. The solid electrolyte layer is in electrical communication with the cathode and the anode and provides an electrically conductive pathway for the movement of charge carriers between the cathode and the anode. In some embodiments, the solid electrolyte layer may be formed over and in direct contact with the cathode or the anode. In other embodiments, another functional layer may be interposed between the solid electrolyte layer and the cathode and/or the anode.

### Materials for Solid Electrolyte Layer Generally

In general, the material of the solid electrolyte layer is not particularly limited as long as it allows adhesion with adjacent layers, has a suitable electrical conductivity, and does not cause significant chemical changes in the solid state battery in the voltage range of the solid state battery. For example, the solid electrolyte layer may include a may include various inorganic solid electrolytes, polymer solid electrolytes, and/or polymer gel electrolytes, although not limited thereto.

### Sulfide-Based/Containing Solid Electrolyte Layer Generally

In the solid state batteries provided herein, the solid electrolyte layer may comprise a sulfide-based/containing material. As used here, “sulfide-based/containing electrolyte” refers to an electrolyte that includes inorganic materials containing S which conduct ions (e.g., Li⁺), and which are suitable for electrically insulating the positive and negative electrodes of an electrochemical cell. The sulfide-based/containing solid electrolyte material includes sulfur (S) and has ionic conductivity of metal belonging to Group I or Group II of the periodic table, and may include Li—P—S-based glass or Li—P—S-based glass ceramics. For example, the sulfide-based/containing solid electrolyte material used herein may include lithium sulfide, silicon sulfide, germanium sulfide and boron sulfide. Non-limiting examples of the inorganic solid electrolyte may include xLi₂S·yP₂S₅ (x+y=1), Li_{3.833}Sn_{0.833}As_{0.166}S₄, Li₄SnS₄, Li_{3.25}Ge_{0.25}P_{0.75}S₄, Li₂S—P₂S₀, B₂S₃—Li₂S, XLi₂S-(100−x)P₂S₅ (x=70-80), Li₂S—SiS₂—Li₃N, Li₂S—P₂S₅—LiI, Li₂S SiS₂—LiI, Li₂S—B₂S₃—LiI, Li₃N, LISICON, LIPON (Li_{3+y}PO₄₋ₓNₓ), thio-LISICON (Li_{3.25}Ge_{0.25}P_{0.75}S₄), Li₂O—Al₂O₃—TiO₂—P₂O₅(LATP), Li₂S—P₂S₅, Li₂S—LiI—P₂S₅, Li₂S—LiI- Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂, Li₂S—GeS₂—ZnS, the like, or combinations thereof.

### Particular Sulfide-Containing Solid Electrolyte Layer

In some embodiments of the solid state battery provided herein, the sulfide-containing solid electrolyte layer may comprise an inorganic-based solid electrolyte material. In some embodiments, the sulfide-containing solid electrolyte material comprises an inorganic-based solid electrolyte material. In some embodiments, the sulfide-containing solid electrolyte material may comprise at least one of Li₃P₇S₁₁, Li₁₀GeP₂S₁₂, Na₃PS₄, Li_{6-y}PS_{5-y}Cl_{1+y} (y<1), and/or Li₆PS₅X (X is Cl, Br, or I).

### Solid Electrolyte Layer Particle Size

In the solid state batteries provided herein, the solid electrolyte layer may comprises provided a solid electrolyte material in the form of particles. In some embodiments, the solid electrolyte material may have a volume-based average particle size from, for example, about 0.1 μm to about 50 μm, about 0.1 μm to about 40 μm, about 0.1 μm to about 30 μm, about 0.1 μm to about 20 μm, about 0.1 μm to about 10 μm, about 0.1 μm to about 5 μm, about 0.1 μm to about 1 μm, about 1 μm to about 50 μm, about 1 μm to about 40 μm, about 1 μm to about 30 μm, about 1 μm to about 20 μm, about 1 μm to about 10 μm, about 1 μm to about 5 μm, about 5 μm to about 50 μm, about 5 μm to about 40 μm, about 5 μm to about 30 μm, about 5 μm to about 20 μm, about 5 μm to about 10 μm, about 10 μm to about 50 μm, about 10 μm to about 40 μm, about 10 μm to about 30 μm, about 10 μm to about 20 μm, about 20 μm to about 50 μm, about 20 μm to about 40 μm, about 20 μm to about 30 μm, about 20 μm to about 50 μm, about 20 μm to about 40 μm, about 20 μm to about 30 μm, about 30 μm to about 50 μm, about 30 μm to about 40 μm, about 40 μm to about 50 μm, etc, as measured by laser diffraction type particle size distribution measurement. In embodiments, the average particle size of the solid electrolyte material can be at or about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 μm. In embodiments, particle size of the solid electrolyte material may be within a range formed by selecting any two numbers listed above or by selecting any two numbers in the range of from about 0.1 μm to about 50 μm.

### Porosity

The solid electrolyte layer maintains a suitable porosity for the lithium ion to travel through the solid electrolyte layer. In some embodiments, the solid electrolyte layer provided herein has a porosity of greater than about 5%, for example, from about 5% to about 15%, from about 5% to about 14%, from about 5% to about 13%, from about 5% to about 12%, from about 5% to about 11%, from about 5% to about 10%, from about 5% to about 9%, from about 5% to about 8%, from about 5% to about 7%, from about 5% to about 6%, or any other % in the range of greater than 5%, such as any other % in the range of from about 5% to about 15% or from 5% to 15%.

### OTHER ASPECTS

The following provides other aspects of the present disclosure. The additional features, embodiments and examples discussed below will be applicable to various aspects of the invention discussed above. In case there is a conflict between information in the foregoing discussions and information in the following discussions, however, the information in the foregoing section should apply.

### Solid State Lithium Ion Batteries

A solid state battery can receive a charge and discharge an electrical load various times. A solid state battery includes electrodes, a cathode electrode and an anode electrode, and an electrolyte to allow lithium ions to travel between the electrodes. In contrast to conventional liquid electrolyte batteries, the solid state battery does not include any flowable liquids. Forming a circuit between the electrodes causes electricity to flow between the electrodes. During charging of the lithium ion rechargeable battery, lithium ions are emitted from the cathode electrode and are intercalated into an active material of the anode electrode. During discharging of the lithium ion rechargeable battery, lithium ions are emitted from the anode electrode and are intercalated into an active material of the cathode electrode. As lithium ions reciprocate between the electrodes, they transfer energy.

### Solid State Battery Configuration

The present disclosure provides a solid state battery 100 comprising a cathode electrode 102, an anode electrode 104, and a solid electrolyte layer 106 intermediate the cathode electrode 102 and the anode electrode 104. While listed as exemplary, the solid state battery 100 does not require all of these components. For example, in some configurations, such as in anodeless system, the anode electrode 104 may be omitted.

### Optional Additional Layers

The solid state battery 100 can optionally comprise an additional layer or layers, such as, for example, a separator layer, a protective layer, an inhibitor layer, a solid electrolyte interface layer, or a combination thereof.

### Protective Layer

For example, a protective layer may be incorporated between the electrodes 102 and 104 and the solid electrolyte layer 106 and/or a protective layer may be between the electrode 102 and current collector 110 in an anodeless system. The protective layer may also serve to mitigate dendrite formation, particularly on the anode side, thereby improving the overall cycle life and safety of the battery. In some cases, the protective layer may help improve interfacial stability between the electrodes and electrolyte, potentially reducing unwanted side reactions. Additionally, the protective layer may enhance the mechanical properties of the electrode-electrolyte interface, which could be beneficial for maintaining good contact during cycling.

### Protective Layer Materials

This protective layer may comprise materials such as lithium phosphate, lithium titanate, lithium lanthanum zirconium oxide (LLZO), which can help prevent undesirable side reactions at the electrode-electrolyte interface. Other options for the protective layer material may include, but are not limited to, lithium niobium oxide (LiNbO3), lithium tantalum oxide (LiTaO3), lithium aluminum titanium phosphate (LATP), lithium aluminum germanium phosphate (LAGP), lithium silicate, and lithium boron oxide.

### Separator Layer

A separator layer may also be included in some configurations of the solid state battery 100. These separator layers can provide additional mechanical support to the battery structure while still allowing for efficient ion transport. The separator layer may also be designed to have a gradient structure, with properties optimized for contact with both the cathode and anode materials. This gradient structure could involve, for example, varying the porosity, composition, or surface properties across the thickness of the separator. In some aspects, the separator surface may be functionalized with ion-conductive groups or coatings to enhance lithium ion transport at the electrode-separator interfaces. The separate layer may further be designed with multiple layers, by incorporating different materials optimized for specific functions, such as a mechanically strong core layer sandwiched between ion-conductive outer layers. The separator layer may additional be designed to be self-healing e.g., by reforming bonds after mechanical stress to help prevent short circuits caused by dendrite growth.

### Separator Layer Materials

While traditional liquid electrolyte batteries often use porous polymer separators, solid state batteries may employ thin ceramic or glass-ceramic layers as separators. Materials such as LLZO, LATP (lithium aluminum titanium phosphate), or LAGP (lithium aluminum germanium phosphate) may be used for this purpose. Other separator layer materials that may be suitable for solid state batteries include lithium phosphate oxynitride (LiPON), lithium lanthanum titanate (LLTO), lithium garnet-type materials like Li6BaLa2Ta2O12, sulfide-based materials like Li10GeP2S12, and polymer-ceramic composites combining materials like polyethylene oxide (PEO) with ceramic fillers.

### Solid State Battery Cell

FIG. 1 illustrates a cell 101 of a solid state battery 100 according to an embodiment. The cell 101 includes a cathode electrode 102, an anode electrode 104, and a solid electrolyte layer 106 intermediate the cathode electrode 102 and the anode electrode 104. The cell 101 can optionally include an additional layer or layers, such as, for example, a separator layer, a protective layer, an inhibitor layer, a solid electrolyte interface layer, or a combination thereof.

### Cell Configuration

As illustrated in FIG. 1, the solid state battery 100 may include a single cell 101. In other examples, the solid state battery 100 can include multiple cells, such as, at least two cells, at least three cells, or at least four cells. Connecting the cells in series increases a voltage of the solid state battery 100 and connecting the cells in parallel increases an amp-hour capacity of the solid state battery 100.

### Dimensions of Cell

The cell 101 may have a width, w₁, a length, l₁, and a thickness, t₁.

### Thickness of Cell

A thickness, t₁, of the cell 101 can be at or about any number in a range of from about 100 μm to about 5000 μm, such as about 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000, 1100, 1200, 1300, 1400, 1500, 1600, 1700, 1800, 1900, 2000, 3000, 4000, or 5000 μm. In some embodiments, the thickness, t₁, of the cell 101 may be within a range formed by selecting any two numbers listed above or by selecting any two numbers within the range of from about 100 μm to about 5000 μm, e.g., between about 100 μm and about 5,000 μm or about 100 μm and about 1,000 μm.

### Aspect Ratio of Width

The width, w₁, of the cell 101 may be substantially greater than the thickness, t₁, of the cell 101. In some embodiments, an aspect ratio of the width, w₁, to the thickness, t₁, may be at least 10, at least 20, at least 30, at least 40, at least 50, at least 60, at least 70, at least 80, at least 90, at least 100, at least 110, at least 120, at least 130, at least 140, at least 150, at least 160, at least 170, at least 180, at least 190, at least 200, at least 210, at least 220, at least 230, at least 240, at least 250, at least 260, at least 270, at least 280, at least 290, at least 300, at least 350, at least 400, at least 450, at least 500, at least 550, at least 600, at least 650, at least 700, at least 750, at least 800, at least 850, at least 900, at least 950, at least 1000, at least 2000, at least 3000, at least 4000, at least 5000, at least 6000, at least 7000, at least 8000, at least 9000, or at least 10000.

### Aspect Ratio of Length

The length, l₁, of the cell 101 may be substantially greater than the thickness, t1, of the cell 101. In some embodiments, an aspect ratio of the the length, l₁, to the thickness, t₁, may be at least 10, at least 20, at least 30, at least 40, at least 50, at least 60, at least 70, at least 80, at least 90, at least 100, at least 110, at least 120, at least 130, at least 140, at least 150, at least 160, at least 170, at least 180, at least 190, at least 200, at least 210, at least 220, at least 230, at least 240, at least 250, at least 260, at least 270, at least 280, at least 290, at least 300, at least 350, at least 400, at least 450, at least 500, at least 550, at least 600, at least 650, at least 700, at least 750, at least 800, at least 850, at least 900, at least 950, at least 1000, at least 2000, at least 3000, at least 4000, at least 5000, at least 6000, at least 7000, at least 8000, at least 9000, or at least 10000.

### Cathode Electrode

The cathode electrode 102 is associated with one polarity (e.g., positive) of the solid state battery 100. The cathode electrode 102 is configured as a positive electrode during discharge of the solid state battery 100. The cathode electrode 102 is suitable for lithium ion diffusion between a current collector 108 and the solid electrolyte layer 106. The cathode electrode 102 is in electrical communication with the current collector 108.

### Cathode Electrode Positioning

In embodiments, the cathode electrode 102 is formed over and in direct contact with the current collector 108. In other embodiments, another functional layer may be interposed between the cathode electrode 102 and the current collector 108.

### Materials for Cathode Electrode

The cathode electrode 102 may be capable of reversible intercalation and deintercalation of lithium ions. For example, the cathode electrode 102 can comprise a cathode active material alone. In other examples, the cathode electrode 102 may optionally include one or more of a conductive carbon, a solid electrolyte material, and a binder. Optionally, the cathode electrode 102 may further comprise an additive, such as, for example, an oxidation stabilizing agent, a reduction stabilizing agent, a flame retardant, a heat stabilizer, an antifogging agent, a thickener, a plasticizer, an ion conductivity enhancer, a binder (described in detail further below), a dispersant, a wetting agent, an adhesion promoter, a crosslinking agent, a colorant, the like, or a combination thereof.

### Examples of Additives

Examples of these additives may include butylated hydroxyanisole (BHA) or butylated hydroxytoluene (BHT) as oxidation stabilizing agents, ascorbic acid or sodium sulfite as reduction stabilizing agents, aluminum hydroxide or magnesium hydroxide as flame retardants, phenolic compounds or phosphites as heat stabilizers, polyethylene glycol or silica nanoparticles as antifogging agents, carboxymethyl cellulose (CMC) or xanthan gum as thickeners, dibutyl phthalate or triethyl citrate as plasticizers, ceramic fillers or ionic liquids as ion conductivity enhancers, polyvinylpyrrolidone or sodium dodecyl sulfate as dispersants, polysorbates or poloxamers as wetting agents, silanes or titanates as adhesion promoters, peroxides or aziridines as crosslinking agents, and carbon black or metal oxides as colorants.

### Cathode Active Material

The cathode active material can include lithium cobalt oxide (LiCoO₂), lithium nickel oxide (LiNiO₂), Li[NiₐCo_{b}Mn_{c}M¹_{d}]O₂ (wherein M¹ is any one element elected from the group consisting of Al, Ga, In, or a combination thereof, 0.3≤a<1.0, 0≤b≤0.5, 0≤c≤0.5, 0≤d≤0.1, and a+b+c+d=1), Li(LiₑM²_{f-e-f}M³_{f′})O_{2-g}A_{g} (wherein 0≤e≤0.2, 0.6≤f≤1, 0≤f′≤0.2, 0≤g≤0.2, M² includes Mn and at least one element selected from the group consisting of Ni, Co, Fe, Cr, V, Cu, Zn and Ti, M³ is at least one element selected from the group consisting of Al, Mg and B, and A is at least one element selected from the group consisting of P, F, S and N), or those compounds substituted with one or more transition metals; lithium manganese oxides such as those represented by the chemical formula of Li^{l+h}Mn₂₋ₕO₄ (wherein 0≤h≤0.33), LiMnO₃, LiMn₂O₃, LiMnO₂, or the like; lithium copper oxide (Li₂CuO₂); vanadium oxides such as LiV₃O₈, V₂O₅ or Cu₂V₂O₇; Ni-site type lithium nickel oxides represented by the chemical formula of LiNi₁₋ᵢM⁴ᵢO₂ (wherein M⁴=Co, Mn, Al, Cu, Fe, Mg, B or Ga, and 0.01≤y≤0.3); lithium manganese composite oxides represented by the chemical formula of LiMn₂₋ⱼM⁵ⱼO₂ (wherein M⁵=Co, Ni, Fe, Cr, Zn, or Ta, and 0.01≤y≤0.1) or Li₂Mn₃M⁶O₈ (wherein M⁶=Fe, Co, Ni, Cu, or Zn); LiMn₂O₄ in which Li is partially substituted with an alkaline earth metal ion; disulfide compounds; LiFe₃O₄, Fe₂(MoO₄)₃; the like; or combinations thereof.

### Phosphate-Based Materials

In addition to the cathode active materials previously mentioned, the cathode electrode may include other types of materials. For example, lithium iron phosphate (LiFePO4) may be used as a cathode active material due to its excellent thermal stability and long cycle life. Other phosphate-based materials such as lithium manganese iron phosphate (LiMnxFe1-xPO4), lithium vanadium phosphate (LiVOPO4), lithium titanium phosphate (LiTi2(PO4)3), lithium nickel phosphate (LiNiPO4), fluorophosphates such as LiVPO4F or LiFeSO4F, or lithium cobalt phosphate (LiCoPO4) may also be suitable.

### Layered Oxide Materials

The cathode active material may also include layered oxide materials with various compositions, such as Li(Ni1-x-yCoxMny)O2 (NCM) or Li(Ni1-x-yCoxAly)O2 (NCA), where the ratios of Ni, Co, Mn, and Al can be adjusted to optimize performance characteristics. For instance, NCM materials with high nickel content, such as NCM811 (LiNi0.8Co0.1Mn0.1O2), may be used to achieve higher energy density. In some cases, the cathode active material may comprise spinel structures like LiNi0.5Mn1.5O4, which can offer high voltage operation. Alternatively, materials with tavorite structures, such as LiFeSO4F or LiVPO4F, may be employed for their potential for high energy density and good thermal stability.

### Composite or Blended Cathode Materials

Composite or blended cathode materials, combining two or more active materials, may also be used. For example, a blend of layered oxides and spinel materials might be employed to balance energy density and power capability. As another example, lithium iron phosphate may be blended with one or more of the cathode active materials described above. In some embodiments, the cathode active material may include surface-modified versions of the aforementioned compounds, where the surface modification aims to improve stability, conductivity, or other performance metrics.

### Emerging Classes of Materials

The cathode active material may also include emerging classes of materials such as disordered rock salt structures (e.g., Li3NbO4-based materials), lithium-rich anti-perovskites (e.g., Li3OCl), cation-disordered oxides (e.g., Li—Mn—V—O systems), or high-entropy oxides, which may offer desirable combinations of high capacity and structural stability. In some cases, the cathode active material may incorporate dopants or substitutional elements to further tune its electrochemical properties.

### Particulate Nature of Cathode Active Material

The cathode active material can be particle shaped. The cathode active material can have a particle size in a range of from about 1 nm to about 1000 μm, such as about any of 10 nm, 20 nm, 30 nm, 40 nm, 50 nm, 60 nm, 70 nm, 80 nm, 90 nm, 100 nm, 110 nm, 120 nm, 130 nm, 140 nm, 150 nm, 160 nm, 170 nm, 180 nm, 190 nm, 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm, 550 nm, 600 nm, 650 nm, 700 nm, 750 nm, 800 nm, 850 nm, 900 nm, 950 nm, 1000 nm, 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, 300 μm, 310 μm, 320 μm, 330 μm, 340 μm, 350 μm, 360 μm, 370 μm, 380 μm, 390 μm, 400 μm, 410 μm, 420 μm, 430 μm, 440 μm, 450 μm, 460 μm, 470 μm, 480 μm, 490 μm, 500 μm, 550 μm, 600 μm, 650 μm, 700 μm, 750 μm, 800 μm, 850 μm, 900 μm, 950 μm, or 1,000 μm. In embodiments, particle size of the cathode active material may be within a range formed by selecting any two numbers listed above or by selecting any two numbers in the range of from about 1 nm to about 1000 μm, e.g., between about 10 nm and about 1,000 μm. Gaps between cathode active material particles in the cathode electrode 102 can be filled with the solid electrolyte material.

### Amount of Cathode Active Material in Cathode Electrode

The amount of the cathode active material in the solid state battery 100 affects the charge and discharge capacity of the solid state battery 100. In order to manufacture a high-capacity cathode electrode 102, a high level of cathode active material can be included in the cathode electrode 102. For example, the cathode electrode 102 includes at, about, or greater than 1, 5, 10, 15, 20, 25, 30, 35, 40, 45, 50, 55, 60, 65, 70, 75, 80, 85, 90, 95, 98, or 99 wt % based on the total weight of the cathode electrode 102. In embodiments, cathode active material in the cathode electrode 102 may be within a range formed by selecting any two numbers listed above or by selecting any two numbers within the range from greater than 0 to about 100 wt %, e.g., between about 40 wt % and about 98 wt %.

### Conductive Material in Cathode Electrode

The conductive material in the cathode electrode 102 is not particularly limited, as long as it has conductivity while not causing any chemical change in the corresponding solid state battery 100. For example, the conductive material can comprise graphite, such as natural graphite or artificial graphite; carbon black, such as acetylene black, ketjen black, channel black, furnace black, lamp black or thermal black; conductive fibers, such as carbon fibers or metal fibers; carbon nanotubes (CNT), including both singled-walled carbon nanotubes (SWCNT) and multi-walled carbon nanotubes (MWCNT); metal powder, such as fluorocarbon, aluminum or nickel powder; conductive whiskers, such as zinc oxide or potassium titanate; conductive metal oxides, such as titanium oxide; conductive polymers, such as polyphenylene derivatives; graphene, metallic nanowires (e.g. silver nanowires), indium tin oxide (ITO), antimony-doped tin oxide (ATO), fluorine-doped tin oxide (FTO), aluminum-doped zinc oxide (AZO), gallium-doped zinc oxide (GZO), conductive ceramics like titanium nitride or titanium carbide, the like, or combinations thereof.

### Amount of Conductive Material in Cathode Electrode

The cathode electrode 102 includes at or about 1, 3, 4, 5, 6, 7, 8, 9, 10, 11, 12, 13, 14, 15, 16, 17, 18, 19, 20, 21, 22, 23, 24, 25, 26, 27, 28, 29, or 30 wt % of conductive material based on the total weight of the cathode electrode 102. In embodiments, conductive material in the cathode electrode 102 may be within a range formed by selecting any two numbers listed in the immediately previous sentence, e.g., between about 1 wt % and about 30 wt %.

### Materials for Binder

The binder can comprise various types of binder polymers, such as, for example, polyvinylidene fluoride-co-hexafluoropropylene (PVdF-co-HFP), polyvinylidene fluoride, polyacrylonitrile, polymethyl methacrylate, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polyacrylate, ethylene-propylene-diene monomer (EPDM), sulfonated EPDM, styrene butadiene rubber (SBR), fluororubber, polyacrylic acid, polyimide, polyamide-imide, polyurethane, polyethylene oxide (PEO), poly(ethylene-co-vinyl acetate) (PEVA), poly(vinyl acetate) (PVA), chitosan, guar gum (GG), xanthan gum, carrageenan, pectin, water-soluble polymers, lignin, polymers thereof whose hydrogen atoms are substituted with Li, Na or Ca, various copolymers thereof, the like, or combinations thereof.

### Other Binder Materials

In addition to the binder materials previously mentioned, other types of binder materials may be used in the cathode electrode to enhance its performance and stability. For instance, water-soluble binders such as sodium alginate, gelatin, or polyacrylamide may be employed to improve the environmental friendliness of the electrode manufacturing process. These binders may also offer advantages in terms of electrode flexibility and adhesion strength. In some cases, conductive binders like poly(3,4-ethylenedioxythiophene):poly(styrene sulfonate) (PEDOT:PSS) or polyaniline (PANI) may be used to simultaneously improve both the mechanical integrity and electrical conductivity of the electrode.

### Novel Binder Systems

Novel binder systems, such as self-healing polymers or supramolecular assemblies, may be incorporated to enhance the long-term stability and cycle life of the battery. Additionally, composite binders combining multiple polymers or incorporating inorganic nanoparticles may be utilized to tailor the mechanical, thermal, and electrochemical properties of the electrode. In some embodiments, bio-derived or biodegradable binders, such as cellulose derivatives or chitosan, may be employed to reduce the environmental impact of battery production and disposal.

### Amount of Binder in the Cathode Electrode

The cathode electrode 102 may include at or about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt % of binder based on the total weight of the cathode electrode 102. In embodiments, binder in the cathode electrode 102 may be within a range formed by selecting any two numbers listed in the immediately previous sentence, e.g., between about 1 wt % and about 30 wt %.

### Solid Electrolyte Material

The solid electrolyte material in the cathode electrode 102 can be configured the same as the material for the solid electrolyte layer 106 discussed below. The solid electrolyte material in the cathode electrode 102 can be the same as or different than the material for the solid electrolyte layer 106.

### Amount of Solid Electrolyte Material in Cathode Electrode

The cathode electrode 102 may include about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt % of solid electrolyte material based on the total weight of the cathode electrode 102. In embodiments, the amount of solid electrolyte material in the cathode electrode 102 may be within a range formed by selecting any two numbers listed in the immediately previous sentence, e.g., between about 1 wt % and about 30 wt %.

### Thickness of Cathode Electrode

A thickness, t₂, of the cathode electrode 102 can be at or about any number in a range of from greater than 0 to 1000 μm, such as 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400,410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1,000 μm. In embodiments, the thickness, t₂, of the cathode electrode 102 may be within a range formed by selecting any two numbers listed above or by selecting any two numbers within the range of from greater than 0 to about 1000 μm, e.g., between about 10 μm and about 1,000 μm.

### Porosity of Cathode Electrode

A porosity of the cathode electrode 102 can be at or about any number in a range of from 0 to 20 vol %, such as 0, 1, 2 3, 4, 5, 6, 7, 8, 9, 10, 11, 12, 13, 14, 15, 16, 17, or 18 vol % or any other vol % within the range of 0 to 20 vol %, based on the total volume of the cathode electrode 102. In embodiments, the porosity of the cathode electrode 102 may be within a range formed by selecting any two numbers listed above or by selecting any two numbers within the range of 0 to 20 vol %, e.g., between 0 vol % and about 18 vol %.

### Lithium Ion Diffusivity of Cathode Electrode

The cathode electrode 102 can include a lithium ion diffusivity at or about any number in a range of from greater than 0 to 1×10⁻⁷ cm²/s, such as 1×10⁻¹⁴ cm²/s, 1×10⁻¹³ cm²/s, 1×10⁻¹² cm²/s, 1×10⁻¹¹ cm²/s, 1×10⁻¹¹ cm²/s, 1×10⁻⁹ cm²/s, 1×10⁻⁸ cm²/s, or 1×10⁻⁷ cm²/s. In embodiments, the lithium ion diffusivity of the cathode electrode 102 may be within a range formed by selecting any two numbers listed above or by selecting any two numbers within the range of from greater than 0 to 1×10⁻⁷ cm²/s, e.g., between 1×10⁻¹⁴ cm²/s and about 1×10⁻⁷ cm²/s.

### Current Collector at Cathode Electrode

The current collector 108 collects electrical energy generated at the cathode electrode 102 and supports the cathode electrode 102.

### Materials for Current Collector at Cathode Electrode

The material of the current collector 108 is not particularly limited as long as it allows adhesion of the cathode electrode 102, has a suitable electrical conductivity, and does not cause significant chemical changes in the corresponding solid state battery 100 in the voltage range of the solid state battery 100. For example, the current collector 108 is made of or includes various materials, such as, a metal, a conductive carbon, or a conductive ceramic, although not limited thereto. The metal of the current collector 108 may include one or more selected from the group consisting aluminum, an aluminum alloy, copper, a copper alloy, nickel, a nickel alloy, titanium, a titanium alloy, iron, an iron alloy (e.g., steel, stainless steel), silver, a silver alloy, gold, platinum, palladium, chromium, molybdenum, tungsten, tantalum, niobium, zirconium, vanadium, manganese, cobalt, indium, tin, lead, bismuth, or a combination thereof, although not limited thereto.

### Current Collector Geometry

The current collector 108 may also be configured in various other geometries to optimize its performance and integration with the cathode electrode 102, and may be sized for specific form factors, such as pouch, cylindrical, and/or prismatic form factors.

### Shape of Current Collector at Cathode Electrode

It is possible to increase the adhesion of the cathode electrode 102 to the current collector 108 by forming fine surface irregularities on the surface of the current collector 108. The current collector 108 may have various shapes, such as, for example, a film, a sheet, a foil, a net, a porous body, a foam, a non-woven web, the like, or combinations thereof.

### Examples of Shape and Size of Current Collector

For instance, the current collector 108 may be structured as a mesh or grid, which can provide enhanced mechanical support while maintaining high surface area for electrode adhesion. In some embodiments, the current collector 108 may be designed with a corrugated or wavy pattern, potentially increasing the contact area with the cathode material and improving overall conductivity. The current collector 108 may also be fabricated as a perforated sheet, allowing for better electrolyte penetration and ion transport. In certain cases, the current collector 108 may be formed as a three-dimensional structure, such as an interconnected network of fibers or a honeycomb-like configuration, which could enhance the structural integrity of the electrode assembly while facilitating efficient current collection.

### Thickness of Current Collector at Cathode Electrode

A thickness, t₃, of the current collector 108 can be at or about any number in a range of from greater than 0 to 500 μm, such as 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400,410, 420, 430, 440, 450, 460, 470, 480, 490, or 500 μm. In embodiments, the thickness, t₃, of the current collector 108 may be within a range formed by selecting any two numbers listed above or by selecting any two numbers within the range of from greater than 0 to 500 μm, e.g., between about 5 μm and about 500 μm.

### Manufacturing Methods for Cathode Electrode

The cathode electrode 102 may be obtained by various methods.

### Dry Powder Coating Process

For instance, a dry powder coating process may be employed, where the cathode active material, conductive additives, and binder are mixed in a dry state and then directly applied to the current collector 108 using electrostatic deposition or mechanical compression. This method may reduce environmental impact by reducing use of solvents.

### 3D Printing

In some cases, the cathode electrode 102 may be fabricated using additive manufacturing techniques such as 3D printing. This approach allows for precise control over the electrode structure and porosity, potentially enhancing the electrode's performance and energy density. Various 3D printing methods, including fused deposition modeling (FDM), selective laser sintering (SLS), or direct ink writing (DIW), may be utilized depending on the specific materials and desired electrode properties.

### Electrospinning

Another method for manufacturing the cathode electrode 102 may involve electrospinning. In this process, a solution containing the cathode active material, conductive additives, and a polymer binder is extruded through a nozzle under an electric field, resulting in the formation of nanofibers. These fibers can be collected directly on the current collector 108 to form a highly porous electrode structure with increased surface area.

### Tape Casting

In some embodiments, the cathode electrode 102 may be prepared using a tape casting method. This technique involves spreading a slurry of electrode materials onto a moving carrier film using a doctor blade, followed by drying and calendaring. The resulting electrode tape can then be laminated onto the current collector 108.

### Spray Coating

Alternatively, the cathode electrode 102 may be fabricated using a spray coating technique. In this method, a fine mist of the electrode slurry is sprayed onto the current collector 108 using compressed air or ultrasonic atomization. This approach may allow for the creation of thin, uniform electrode layers and can be particularly useful for large-scale production.

### Freeze-Casting

In certain cases, the cathode electrode 102 may be manufactured using a freeze-casting method. This process involves freezing a slurry of electrode materials, followed by sublimation of the ice to create a porous structure. The resulting porous electrode can then be sintered and attached to the current collector 108.

### Sol-Gel Process

For some applications, the cathode electrode 102 may be prepared using a sol-gel process. This method involves the formation of a colloidal suspension (sol) that is then converted into a gel-like network containing the cathode active material and other components. The gel can be applied to the current collector 108 and subsequently heat-treated to form the final electrode structure.

### Slurry-Based Process

For example, the cathode active material can be mixed and agitated with a solvent, and optionally a binder, conductive material, and a dispersing agent to form slurry. Then, the slurry can be applied (e.g., coated) onto the current collector 108, followed by pressing and drying, to obtain the cathode electrode 102.

### Application Methods for Slurry for Cathode Electrode

The application of the slurry to the cathode electrode 102 may include using a technique selected from the group consisting of slot die coating, gravure coating, spin coating, spray coating, roll coating, curtain coating, extrusion, casting, screen printing, inkjet printing, spray printing, gravure printing, heat transfer printing, a Toppan printing method, intaglio printing, offset printing, the like, and combinations thereof.

### Double Layer Slot Die Coating

In some embodiments, the cathode electrode 102 may be fabricated using a double layer slot die coating (DLD) technique. This method involves the simultaneous application of two distinct layers of electrode materials onto the current collector 108 in a single pass. The DLD process may allow for the creation of gradient structures within the electrode, potentially optimizing both the electrochemical performance and mechanical properties of the cathode. Additionally, this technique may enable the incorporation of functional interlayers or protective coatings as part of the electrode manufacturing process, potentially enhancing the overall battery performance and longevity.

### Solvent for Slurry for Cathode Electrode

The solvent for forming the cathode electrode 102 may include water and/or an organic solvents, such as, for example, N-methyl pyrrolidone (NMP), dimethyl formamide (DMF), acetone, dimethyl acetamide, dimethyl sulfoxide (DMSO), isopropyl alcohol, the like, or combinations thereof. The solvent may be used in an amount sufficient to dissolve and disperse the electrode ingredients, such as the cathode active material, binder, and conductive material, considering the slurry coating thickness, production yield, the like, or combinations thereof. Additional solvents that may be used include ethanol, methanol, propanol, butanol, ethyl acetate, methyl ethyl ketone, tetrahydrofuran, diethyl ether, and toluene.

### Solvent-Free Methods

In some aspects of the disclosure, the cathode electrode 102 may be prepared using a solvent-free method, such as dry powder processing or melt extrusion, which reduce the use of liquid solvents and may offer environmental and cost benefits.

### Dispersing Agent for Slurry for Cathode Electrode

The dispersing agent forming the cathode electrode 102 may include an aqueous dispersing agent and/or an organic dispersing agent, such as, for example, N-methyl-2-pyrrolidone. Other possible dispersing agents may include polyvinylpyrrolidone (PVP), carboxymethyl cellulose (CMC), sodium dodecyl sulfate (SDS), Triton X-100, polyethylene glycol (PEG), polyacrylic acid (PAA), and various surfactants such as polysorbates or poloxamers.

### Drying Technique for Slurry for Cathode Electrode

The slurry for the cathode electrode 102 may be dried by irradiating heat, electron beams (E-beams), gamma rays, or UV (G, H, I-line), the like, or combinations thereof, to vaporize the solvent. For example, the slurry may be vacuum dried at room temperature. Although the solvent is removed through evaporation by the drying step, the other ingredients do not evaporate and remain as they are to form the cathode electrode 102.

### Additional Drying Techniques

In addition to the drying techniques mentioned, the cathode electrode 102 may be dried using other methods such as infrared (IR) drying, microwave drying, or freeze-drying.

### Combination of Drying Techniques

In some embodiments, a combination of drying techniques may be employed, such as using convection heating followed by vacuum drying, to optimize the drying process and ensure complete solvent removal while maintaining the integrity of the electrode structure.

### Anode Electrode Generally

The anode electrode 104 is associated with one polarity (e.g., negative) of the solid state battery 100, which is different than the polarity of the cathode electrode 102. The anode electrode 104 is configured as a negative electrode during discharge of the solid state battery 100. The anode electrode 104 is suitable for lithium ion diffusion between a current collector 110 and the solid electrolyte layer 106.

### Anode Electrode Positioning

The anode electrode 104 is in electrical communication with the current collector 110. In embodiments, the anode electrode 104 is formed over and in direct contact with the current collector 110. In other embodiments, another functional layer may be interposed between the anode electrode 104 and the current collector 110.

### Anodeless Electrode System

In some embodiments, as explained above, the solid state battery 100 may utilize an anodeless electrode system. In such configurations, the anode electrode 104 may be omitted, and lithium metal may be deposited directly onto the current collector 110 during charging. This approach may potentially increase the energy density of the battery and eliminate a separate anode material, while also potentially reducing the overall thickness of the battery structure.

### Materials for Anode Electrode

The anode electrode 104 may be capable of reversible intercalation and deintercalation of lithium ions. For example, the anode electrode 104 can comprise an anode active material alone. In other examples, the anode electrode 104 may include conductive particles, a binder, the like, or combinations thereof.

### Additives for Anode Electrode

Optionally, the anode electrode 104 may further comprise an additive, such as, for example, an oxidation stabilizing agent (e.g., butylated hydroxyanisole, butylated hydroxytoluene, propyl gallate, tert-butylhydroquinone), a reduction stabilizing agent (e.g., ascorbic acid, sodium sulfite, erythorbic acid, sodium metabisulfite), a flame retardant (e.g., aluminum hydroxide, magnesium hydroxide, ammonium polyphosphate, melamine cyanurate), a heat or light stabilizer (e.g., phenolic compounds, phosphites, hindered amine light stabilizers, UV absorbers like benzophenones or benzotriazoles), an antifogging agent (e.g., polyethylene glycol, silica nanoparticles, glycerol, sorbitol), a thickener (e.g., carboxymethyl cellulose, xanthan gum), the like, or a combination thereof.

### Other Additives for Anode Electrode

Additionally, conductive additives such as carbon black, graphene, or carbon nanotubes may be incorporated to enhance electrical conductivity, while binder modifiers like styrene-butadiene rubber or polyacrylic acid may improve adhesion and mechanical stability. Functional additives such as fluoroethylene carbonate or vinylene carbonate may also be included to promote the formation of a stable solid electrolyte interphase layer on the anode surface.

### Materials for Anode Active Material

The anode active material is made of or includes various materials, such as, for example, an alkali earth metal, an alkaline earth metal, a group 3B metal, a transition metal, a metalloid, an alloy thereof, a conductive carbon, the like, or a combination thereof, although not limited thereof. In embodiments, the anode active material can comprise silicon, a silicon alloy, lithium, a lithium alloy, a conductive carbon, or a combination thereof, although not limited thereto. In embodiments, the lithium alloy is made of or includes a lithium alloy comprising silicon, chlorine, or a combination thereof. A lithium metal thin film may be used as the anode active material.

### Other Materials Anode Active Materials

The anode active material can include carbon-based material such as artificial graphite, natural graphite, graphitized carbon fiber, amorphous carbon or the like; a metallic compound capable of alloying with lithium such as Si, Al, Sn, Pb, Zn, Bi, In, Mg, Ga, Cd, a Si alloy, a Sn alloy, an Al alloy, or the like; a metal oxide capable of doping and dedoping lithium ions such as SiOₓ (0<x<2), SnO₂, vanadium oxide or lithium vanadium oxide; and a composite including the metallic compound and the carbon-based material such as a Si—C composite or a Sn—C composite.

### Carbon-Based Materials

The carbon-based material can include low-crystallinity carbon, high-crystallinity carbon, the like, or combinations thereof. A representative example of low-crystallinity carbon is soft carbon or hard carbon, and a representative example of the high-crystallinity carbon is high-temperature calcined carbon such as amorphous, platy, flaky, spherical or fibrous natural graphite or artificial graphite, kish graphite, pyrolytic carbon, mesophase pitch-based carbon fiber, meso-carbon microbeads, mesophase pitches, petroleum or coal tar pitch-derived coke, the like, or combinations thereof.

### Metal Carbon Composite Materials

Alternatively, according to aspects of the disclosure, the anode electrode 104 may comprise an anode material with a metal carbon composite, such as a silver-carbon blend or composite, where silver particles are complexed between amorphous and/or crystalline carbon particles. Here silver is used as an example, and other metals may be used, including for example, tin and/or zinc. Silicon can be used in place of the silver.

### Further Materials for Anode Active Material

In addition to the materials mentioned, the anode active material may also include titanium-based compounds such as lithium titanate (Li4Ti5O12) or titanium dioxide (TiO2), which can offer excellent cycling stability and high-rate capability. Other potential materials may include transition metal oxides like molybdenum oxides (MoOx), iron oxides (FeOx), or nickel oxides (NiOx), which can provide high theoretical capacities. In some cases, composite materials combining different active materials, such as silicon-graphite composites or tin-carbon composites, may be used to leverage the advantages of multiple materials while mitigating their individual limitations.

### Dendrite Formation

When the anode electrode 104 is made of or includes lithium or a lithium alloy, dendrites may form on the anode electrode 104. The dendrites are a metallic lithium structure formed when extra lithium ions accumulate on a surface of the anode electrode 104. The formed dendrites may damage the solid electrolyte layer 106, reduce battery capacity of the solid state battery 100, and/or otherwise lead to undesired performance of the solid state battery 100. Dendrite formation is a significant challenge in lithium-based batteries, as these structures can grow through the electrolyte, potentially causing short circuits and safety hazards. The growth rate and morphology of dendrites may be influenced by factors such as current density, temperature, and the nature of the electrolyte-electrode interface.

### Advantages of Solid Electrolytes in Mitigating Dendrite Formation

Solid electrolytes offer several advantages over liquid electrolytes when it comes to mitigating dendrite formation. The mechanical strength of solid electrolytes may help suppress dendrite growth by providing a physical barrier to lithium metal penetration. Additionally, the uniform ion distribution in solid electrolytes may promote more even lithium deposition, reducing the likelihood of localized dendrite nucleation. Some solid electrolytes may also form a stable interface with the lithium metal anode, further inhibiting dendrite formation. However, while solid electrolytes can significantly reduce the risk of dendrite growth, they may not completely eliminate it, and ongoing research aims to develop advanced solid electrolyte materials with enhanced dendrite suppression capabilities.

### Shape of Anode Active Material

The anode active material can be particle shaped or it may be a continuous, unitary form (e.g., a thin film or sheet).

### Particle Size

In embodiments where the anode active material is particle shaped, the anode active material can comprise a particle size of any number in a range from at or about 10 nm to at or about 1000 μm, such as at or about 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, 110 nm, 120 nm, 130 nm, 140 nm, 150 nm, 160 nm, 170 nm, 180 nm, 190 nm, 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1000 nm, 2 m, 3 μm, 4 μm, 5 μm, 6 μm, 7 μm, 8 μam, 9 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, 300 μm, 310 μm, 320 μm, 330 μm, 340 μm, 350 μm, 360 μm, 370 μm, 380 μm, 390 μm, 400 μm, 410 μm, 420 μm, 430 μm, 440 μm, 450 μm, 460 μm, 470 μm, 480 μm, 490 μm, 500 μm, 510 μm, 520 μm, 530 μm, 540 μm, 550 μm, 560 μm, 570 μm, 580 μm, 590 μm, 600 μm, 610 μm, 620 μm, 630 μm, 640 μm, 650 μm, 660 μm, 670 μm, 680 μm, 690 μm, 700 μm, 710 μm, 720 μm, 730 μm, 740 μm, 750 μm, 760 μm, 770 μm, 780 μm, 790 μm, 800 μm, 810 μm, 820 μm, 830 μm, 840 μm, 850 μm, 860 μm, 870 μm, 880 μm, 890 μm, 900 μm, 910 μm, 920 μm, 930 μm, 940 μm, 950 μm, 960 μm, 970 μm, 980 μm, 990 μm, or 1,000 μm. In embodiments, particle size of the anode active material may be within a range formed by selecting any two numbers listed above or by selecting any two numbers in the range of from at or about 10 nm to at or about 1000 μm, e.g., between about 10 nm and about 1,000 μm.

### Amount of Anode Active Material in Anode Electrode

The amount of the anode active material in the solid state battery 100 affects the charge and discharge capacity of the solid state battery 100. In order to manufacture a high-capacity anode electrode 104, a high level of anode active material can be included in the anode electrode 104. For example, the anode electrode 104 includes at, about, or greater than 70, 80, 90, 95, 98, 99, or 100 wt % of anode active material based on the total weight of the anode electrode 104. In embodiments, anode active material in the anode electrode 104 may be within a range formed by selecting any two numbers listed in the immediately previous sentence, e.g., between about 70 wt % and about 100 wt %.

### Materials for Binder in Anode Electrode

The binder can comprise various types of binder polymers, such as, for example, polyvinylidene fluoride-co-hexafluoropropylene (PVdF-co-HFP), polyvinylidene fluoride, polyacrylonitrile, polymethyl methacrylate, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polyacrylate, ethylene-propylene-diene monomer (EPDM), sulfonated EPDM, styrene butadiene rubber (SBR), fluororubber, polyacrylic acid, polymers thereof whose hydrogen atoms are substituted with Li, Na or Ca, various copolymers thereof, the like, or combinations thereof.

### Examples of Materials for Binder in Anode Electrode

In addition to the binders mentioned, other suitable binders for use in the anode electrode may include polyimide, polyamide-imide, polyurethane, polyethylene oxide (PEO), poly(ethylene-co-vinyl acetate) (PEVA), poly(vinyl acetate) (PVA), alginate, chitosan, guar gum, xanthan gum, carrageenan, pectin, gelatin, lignin, and various water-soluble polymers or their derivatives. In some cases, conductive polymers such as polypyrrole, polyaniline, or poly(3,4-ethylenedioxythiophene) (PEDOT) may also be used as binders to simultaneously improve adhesion and electrical conductivity within the anode electrode.

### Amount of Binder in Anode Electrode

The anode electrode 104 may include at or about 0, 1, 2, 3, 4, 5, 6, 7, 8, 9, 10, 11, 12, 13, 14, 15, 17, 18, 19, 20, 21, 22, 23, 24, 25, 26, 27, 28, 29, or 30 wt %, or any other wt % in the range between 0 and 30 wt % of binder based on the total weight of the anode electrode 104. In embodiments, binder in the anode electrode 104 may be within a range formed by selecting any two numbers listed above or by selecting any two numbers in the range between 0 and 30 wt %, e.g., between about 0 wt % and about 30 wt %.

### Thickness of Anode Electrode

The anode electrode 104 can have a thickness of at or about 10, 15, 20, 25, 30, 35, 40, 45, 50, 55, 60, 65, 70, 75, 80, 85, 90, 95, or 100 μm. In embodiments, the thickness, t₄, of the anode electrode 104 may be within a range formed by selecting any two numbers listed above or by selecting any two numbers in the range of from 10 μm to about 100 μm, e.g., between about m and about 100 μm or about 10 μm and about 20 μm.

### Porosity of Anode Electrode

A porosity of the anode electrode 104 can be about 0, 1, 2, 3, 4, 5, 6, 7, 8, 9, 10, 11, 12, 13, 14, 15, 16, 17, or 18 vol %, or any other vol % in the range from 0 to 18 vol %, based on the total volume of the anode electrode 104. In embodiments, the porosity of the anode electrode 104 may be within a range formed by selecting any two numbers listed above or by selecting any two numbers in the range from between 0 vol % to about 18 vol %.

### Lithium Ion Diffusivity of Anode Electrode.

The anode electrode 104 may include a lithium ion diffusivity of at or about 1×10⁻¹⁴ cm²/s, 1×10⁻¹³ cm²/s, 1×10⁻¹² cm²/s, 1×10⁻¹¹ cm²/s, 1×10⁻¹¹ cm²/s, 1×10⁻⁹ cm²/s, 1×10⁻⁸ cm²/s, or 1×10⁻⁷ cm²/s. In embodiments, the lithium ion diffusivity of the anode electrode 104 may be within a range formed by selecting any two numbers listed above or by selecting any two numbers in the range from at or about 1×10⁻¹⁴ cm²/s to at or about 1×10⁻⁷ cm²/s.

### Current Collector at Anode Electrode

The current collector 110 collects electrical energy generated at the anode electrode 104 and supports the anode electrode 104.

### Materials for Current Collector at Anode Electrode

The material of the current collector 110 is not particularly limited as long as it allows adhesion of the anode electrode 104, has a suitable electrical conductivity, and does not cause significant chemical changes in the corresponding solid state battery 100 in the voltage range of the solid state battery 100. For example, the current collector 110 is made of or includes a metal or a conductive carbon, although not limited thereto.

### Metal for Current Collector

The metal of the current collector 110 may include one or more selected from the group consisting aluminum, an aluminum alloy, copper, a copper alloy, nickel, a nickel alloy, titanium, a titanium alloy, iron, an iron alloy (e.g., steel, stainless steel), silver, a silver alloy, or a combination thereof, although not limited thereto.

### Shape of Current Collector at Anode Electrode

It is possible to increase the adhesion of the anode electrode 104 to the current collector 110 by forming fine surface irregularities on the surface of the current collector 110. The current collector 110 may have various shapes, such as, for example, a film, a sheet, a foil, a net, a porous body, a foam, a non-woven web body, the like, or combinations thereof. In addition to the shapes mentioned, the current collector 110 may also be configured as a honeycomb structure, a perforated sheet, a woven or non-woven mesh, a sintered porous body, or a three-dimensional interconnected network. These various shapes can be tailored to optimize the surface area, mechanical strength, and current collection efficiency of the current collector 110.

### Design of Current Collector at Anode Electrode

Furthermore, the current collector 110 may be designed to accommodate different form factors of solid state batteries, such as pouch cells, cylindrical cells, or prismatic cells, each may offer advantages in terms of packaging efficiency, thermal management, and overall battery performance.

### Thickness of Current Collector at Anode Electrode

A thickness, t₅, of the current collector 110 can be at or about 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, or 500 μm. In embodiments, the thickness, t₅, of the current collector 110 may be within a range formed by selecting any two numbers listed above or by selecting any two numbers in the range of from at or about 1 μm to at or about 500 μm, e.g., between about 5 μm and about 500 μm.

### Manufacturing Methods for Anode Electrode

The anode electrode 104 may be obtained by various methods, such as, for example, atomic deposition, extrusion, rolling, a slurry method, or a combination thereof. In addition to the methods mentioned, the anode electrode 104 may be manufactured using various other techniques, including dry electrode processes. These alternative methods may offer advantages in terms of environmental impact, cost-effectiveness, and scalability.

### Dry Powder Coating

Dry powder coating may be employed as an alternative to the slurry method. In this process, the anode active material, conductive additives, and binder are mixed in a dry state and then directly applied to the current collector 110 using electrostatic deposition or mechanical compression. This method may reduce the use of solvents, potentially reducing environmental impact and processing time.

### 3D Printing

Additive manufacturing techniques, such as 3D printing, may be used to fabricate the anode electrode 104. Various 3D printing methods, including fused deposition modeling (FDM), selective laser sintering (SLS), or direct ink writing (DIW), can be utilized depending on the specific materials and desired electrode properties. This approach allows for precise control over the electrode structure and porosity.

### Electrospinning

Electrospinning is another potential method for manufacturing the anode electrode 104. In this process, a solution containing the anode active material, conductive additives, and a polymer binder is extruded through a nozzle under an electric field, resulting in the formation of nanofibers. These fibers can be collected directly on the current collector 110 to form a highly porous electrode structure with increased surface area.

### Tape Casting

Tape casting may be employed to prepare the anode electrode 104. This technique involves spreading a slurry of electrode materials onto a moving carrier film using a doctor blade, followed by drying and calendaring. The resulting electrode tape can then be laminated onto the current collector 110.

### Spray Coating

Spray coating techniques may be used to fabricate the anode electrode 104. A fine mist of the electrode slurry is sprayed onto the current collector 110 using compressed air or ultrasonic atomization. This approach may allow for the creation of thin, uniform electrode layers and can be particularly useful for large-scale production.

### Freeze-Casting

Freeze-casting is another potential method for manufacturing the anode electrode 104. This process involves freezing a slurry of electrode materials, followed by sublimation of the ice to create a porous structure. The resulting porous electrode can then be sintered and attached to the current collector 110.

### Sol-Gel Process

In some cases, a sol-gel process may be used to prepare the anode electrode 104. This method involves the formation of a colloidal suspension (sol) that is then converted into a gel-like network containing the anode active material and other components. The gel can be applied to the current collector 110 and subsequently heat-treated to form the final electrode structure.

### Vapor Deposition

For certain applications, physical vapor deposition (PVD) or chemical vapor deposition (CVD) techniques may be employed to create thin film anodes directly on the current collector 110. These methods can produce highly uniform and dense electrode layers, which may be particularly beneficial for certain types of solid-state batteries.

### Alloying and Ball Milling

Mechanical alloying and high-energy ball milling may be used to prepare composite anode materials, which can then be pressed into electrodes or applied to the current collector 110 using one of the aforementioned methods. This technique can be particularly useful for creating nanostructured or amorphous anode materials with enhanced electrochemical properties.

### Slurry Method

For example, the anode active material can be mixed and agitated with a solvent, and optionally a binder, and a dispersing agent to form slurry. Then, the slurry can be applied (e.g., coated) onto the current collector 110, followed by pressing and drying, to obtain the anode electrode 104.

### Application Methods for Slurry for Anode Electrode

The application of the slurry for the anode electrode 104 may include using a technique selected from the group consisting of slot die coating, gravure coating, spin coating, spray coating, roll coating, curtain coating, extrusion, casting, screen printing, inkjet printing, spray printing, gravure printing, heat transfer printing, a Toppan printing method, intaglio printing, offset printing, the like, and combinations thereof. In addition to the aforementioned techniques, other methods for applying the anode slurry to the current collector may include doctor blade coating, dip coating, and meniscus coating.

### Double Slot Die Layer Coating

Double slot die layer coating may also be employed, which allows for the simultaneous application of two distinct layers of electrode materials onto the current collector in a single pass. This method can potentially enable the creation of gradient structures within the electrode, optimizing both electrochemical performance and mechanical properties.

### Solvent for Slurry for Anode Electrode

The solvent for forming the anode electrode 104 may include water and/or an organic solvents, such as, for example, N-methyl pyrrolidone (NMP), dimethyl formamide (DMF), acetone, dimethyl acetamide, dimethyl sulfoxide (DMSO), isopropyl alcohol, the like, or combinations thereof. The solvent may be used in an amount sufficient to dissolve and disperse the electrode ingredients, such as the anode active material and binder, considering the slurry coating thickness, production yield, the like, or combinations thereof. Additional organic solvents that may be used include ethanol, methanol, propanol, butanol, ethyl acetate, methyl ethyl ketone, tetrahydrofuran, diethyl ether, and toluene.

### Solvent-Free Methods

In some embodiments, the anode electrode 104 may be prepared using a solvent-free method, such as dry powder processing or melt extrusion, which eliminates the need for liquid solvents and may offer environmental and cost benefits.

### Dispersing Agent for Slurry for Anode Electrode

The dispersing agent forming the anode electrode 104 may include an aqueous dispersing agent and/or an organic dispersing agent, such as, for example, N-methyl-2-pyrrolidone. Other examples of aqueous dispersing agents may include sodium dodecyl sulfate (SDS), polyvinylpyrrolidone (PVP), and carboxymethyl cellulose (CMC), while additional organic dispersing agents may include Triton X-100, polyethylene glycol (PEG), and various surfactants such as polysorbates or poloxamers.

Methods without a Dispersing Agent

In some embodiments, the anode electrode 104 may be prepared using methods that do not require a dispersing agent, such as dry powder processing or certain additive manufacturing techniques.

### Drying Technique for Slurry for Anode Electrode

The slurry for the anode electrode 104 may be dried by irradiating heat, electron beams (E-beams), gamma rays, or UV (G, H, I-line), the like, or combinations thereof, to vaporize the solvent. For example, the slurry may be vacuum dried at room temperature. Although the solvent is removed through evaporation by the drying step, the other ingredients do not evaporate and remain as they are to form the anode electrode 104.

### Other Drying Techniques

In addition to the drying techniques mentioned, several other methods may be employed to dry the anode electrode slurry. These additional techniques can offer various advantages depending on the specific materials, production requirements, and desired electrode properties.

### Infrared (IR) Drying

Infrared (IR) drying may be used to rapidly heat the electrode surface, promoting efficient solvent evaporation. This method can be particularly effective for thin electrode coatings and may allow for precise control of the drying process.

### Microwave Drying

Microwave drying is another option that can provide volumetric heating of the electrode material, potentially leading to more uniform drying throughout the electrode thickness. In some cases, a combination of convection and microwave drying may be employed to optimize both drying speed and uniformity.

### Freeze-Drying

Freeze-drying, also known as lyophilization, may be utilized for certain electrode formulations. This process involves freezing the slurry and then sublimating the solvent under vacuum conditions. Freeze-drying can help maintain the porous structure of the electrode, which may be beneficial for electrolyte penetration and ion transport.

### Supercritical CO2 Drying

Supercritical CO₂ drying is an advanced technique that may be employed for specialized electrode materials. This method involves replacing the solvent with liquid CO₂, which is then brought to its supercritical state and vented. This approach can help preserve delicate nanostructures within the electrode and may be particularly useful for aerogel-based electrodes.

### Two-Step Drying

In some cases, a two-step drying process may be employed. For example, initial drying may be performed at a lower temperature to remove bulk solvent, followed by a higher temperature step to remove residual solvent and potentially initiate any desired chemical reactions within the electrode material.

### Ultrasonic Drying

Ultrasonic drying may also be considered for certain electrode formulations. This technique uses high-frequency sound waves to agitate the solvent molecules, potentially accelerating the drying process and improving solvent removal from porous structures within the electrode.

### Solid Electrolyte Layer Generally

The solid electrolyte layer 106 is suitable for lithium ion diffusion between the cathode electrode 102 and the anode electrode 104. The solid electrolyte layer 106 provides an electrically conductive pathway for the movement of charge carriers between the cathode electrode 102 and the anode electrode 104. The solid electrolyte layer 106 is in electrical communication with the cathode electrode 102 and the anode electrode 104.

### Solid Electrolyte Positioning

In embodiments, the solid electrolyte layer 106 is formed over and in direct contact with the cathode electrode 102 or the anode electrode 104. In embodiments, the solid electrolyte layer 106 is in direct contact with the cathode electrode 102 and the anode electrode 104. In other embodiments, another functional layer may be interposed between the solid electrolyte layer 106 and the cathode electrode 102 and/or the anode electrode 104.

### Materials for Solid Electrolyte Layer

The solid electrolyte layer 106 may be capable of transport of lithium ions. The material of the solid electrolyte layer 106 is not particularly limited as long as it allows adhesion with adjacent layers, has a suitable electrical conductivity, and does not cause significant chemical changes in the corresponding solid state battery 100 in the voltage range of the solid state battery 100. For example, the solid electrolyte layer 106 may include various inorganic solid electrolytes, polymer solid electrolytes, and/or polymer gel electrolytes, although not limited thereto. Additionally or alternatively, the solid electrolyte layer 106 may include ceramic electrolytes, glass electrolytes, hybrid organic-inorganic electrolytes, and nanostructured electrolytes, although not limited to these categories.

### Inorganic Solid Electrolyte

The inorganic solid electrolyte may include a crystalline solid electrolyte, a non-crystalline solid electrolyte, a glass ceramic solid electrolyte, the like, or a combination thereof, although not limited thereto. The inorganic solid electrolyte may be sulfide-based, oxide-based, the like, or a combination thereof. In addition to sulfide-based and oxide-based inorganic solid electrolytes, other types of inorganic solid electrolytes may include halide-based electrolytes, nitride-based electrolytes, and borate-based electrolytes. For example, lithium-rich anti-perovskites (LiRAP) such as Li3OCl and Li3OBr, lithium nitride (Li3N), and lithium borohydride (LiBH4) have been investigated as potential solid electrolyte materials for lithium-ion batteries.

### Sulfide Based Solid Electrolyte

The sulfide-based solid electrolyte includes sulfur (S) and has ionic conductivity of metal belonging to Group I or Group II of the periodic table, and may include Li—P—S-based glass or Li—P—S-based glass ceramics.

### Examples of Sulfide-Based Solid Electrolyte

For example, the sulfide-based solid electrolyte may include lithium sulfide, silicon sulfide, germanium sulfide and boron sulfide. Particular examples of the inorganic solid electrolyte may include Li_{3.833}Sn_{0.833}As_{0.166}S₄, Li₄SnS₄, Li_{3.25}Ge_{0.25}P_{0.75}S₄, Li₂S—P₂S₀, B₂S₃—Li₂S, XLi₂S-(100−x)P₂S₅ (x=70-80), Li₂S—SiS₂—Li₃N, Li₂S—P₂S₅—LiI, Li₂S—SiS₂—LiI, Li₂S—B₂S₃—LiI, Li₃N, LISICON, UPON (Li_{3+y}PO₄₋ₓNₓ), thio-LISICON (Li_{3.25}Ge_{0.25}P_{0.75}S₄), Li₂O—Al₂O₃—TiO₂—P₂O₅(LATP), Li₂S—P₂S₅, Li₂S—LiI—P₂S₅, Li₂S—LiI—Li₂O—P₂S₅, Li₂S LiBr—P₂S₅, Li₂S Li₂O—P₂S₅, Li₂S—Li₃PO₄—P₂S₅, Li₂S—P₂S₅—P₂O₅, Li₂S P₂S₅—SiS₂, Li₂S—P₂S₅—SnS, Li₂S—P₂S₅—Al₂S₃, Li₂S—GeS₂, Li₂S—GeS₂—ZnS, Li10GeP2S12 (LGPS), Li7P3S11, Li6PS5Cl, Li6PS5Br, Li6PS5I, Li9.54Si1.74P1.44S11.7Cl0.3, Li11Si2PS12, the like, or combinations thereof.

### Doped Variants

In some cases, doped variants of these materials, such as Al-doped Li10GeP2S12 or Sb-doped Li6PS5Cl, may also be employed to further enhance ionic conductivity or stability.

### Oxide Based Solid Electrolyte

The oxide-based solid electrolyte material contains oxygen (O) and has ionic conductivity of metal belonging to Group I or II of the periodic table.

### Examples of Oxide-based Solid Electrolyte Material

The oxide-based solid electrolyte material may include at least one selected from the group consisting of LLTO-based compounds, Li₆La₂CaTa₂O₁₂, Li₆La₂ANb₂O₁₂ (A is Ca or Sr), Li₂Nd₃TeSbO₁₂, Li₃BO_{2.5}N_{0.5}, Li₉SiA₁O₈, LAGP-based compounds, LATP-based compounds, Li₁₊ₓTi₂₋ₓAlₓSi_{y}(PO₄)_{3-y} (0≤x≤1, 0≤y≤1), LiAlₓZr_{2-x (}PO₄)₃(0≤x≤1, 0≤y≤1), LiTiₓZr₂₋ₓ(PO₄)₃ (0≤x≤1, 0≤y≤1), LISICON-based compounds, LIPON-based compounds, perovskite-based compounds, NASICON-based compounds and LLZO-based or derived compounds (such as Al-doped Li7La3Zr2O12 and Ta-doped Li7La3Zr2O12). Lithium-rich anti-perovskites like Li3OCl and Li3OBr have also been investigated as potential oxide-based solid electrolytes.

### Composite Oxide Electrolyte

In some cases, composite oxide electrolytes combining multiple oxide materials, such as LLZO-LATP composites, may be employed to leverage the advantages of different oxide systems.

### Polymer Solid Electrolyte

The polymer solid electrolyte is a composite of electrolyte salt with polymer resin and has lithium ion conductivity. The polymer solid electrolyte may include a polyether polymer, a polycarbonate polymer, an acrylate polymer, a polysiloxane polymer, a phosphazene polymer, a polyethylene derivative, an alkylene oxide derivative, a phosphate polymer, a polyagitation lysine, a polyester sulfide, a polyvinyl alcohol, a polyvinylidene fluoride, a polymer containing an ionically dissociable group, poly(ethylene imine) (PEI), poly(methyl methacrylate) (PMMA), poly(acrylonitrile) (PAN), poly(ethylene succinate) (PES), biopolymers such as chitosan and cellulose derivatives, the like, or combinations thereof.

### Polymer Resin for the Solid Polymer Electrolyte

The solid polymer electrolyte may include a polymer resin, such as a branched copolymer including polyethylene oxide (PEO) backbone copolymerized with a comonomer including an amorphous polymer, such as, for example, PMMA, polycarbonate, polydiloxane (pdms) and/or phosphazene, comb-like polymer, crosslinked polymer resin, polyethylene glycol (PEG), polypropylene oxide (PPO), polyacrylonitrile (PAN), poly(methyl methacrylate) (PMMA), poly(vinylidene fluoride-co-hexafluoropropylene) (PVDF-HFP), poly(ethylene oxide-co-propylene oxide) (PEO-PPO), poly(ethylene imine) (PEI), poly(vinyl pyrrolidone) (PVP), poly(vinyl alcohol) (PVA), various block copolymers or graft copolymers incorporating these materials, the like, or combinations thereof.

### Polymer Gel Electrolyte

The polymer gel electrolyte can be formed by incorporating an organic electrolyte containing an organic solvent and an electrolyte salt, an ionic liquid, monomer, or oligomer to a polymer resin, the like, or combinations thereof. The polymer resin for the polymer gel can include polyether polymers, PVC polymers, PMMA polymers, polyacrylonitrile (PAN), polyvinylidene fluoride (PVDF), poly(vinylidene fluoride-co-hexafluoropropylene: PVDF-co-HFP), the like, or combinations thereof.

### Examples of Polymer Gel Electrolyte

Examples of polymer gel electrolytes that may be suitable for solid state batteries include poly(ethylene oxide) (PEO), poly(methyl methacrylate-co-ethyl acrylate) (PMMA-EA), poly(acrylonitrile-co-methyl methacrylate) (PAN-MMA), poly(vinyl acetate) (PVAc), poly(ethylene glycol diacrylate) (PEGDA), poly(vinyl pyrrolidone) (PVP), poly(ethylene glycol physical properties of the solid electrolyte.

### Electrolyte Salt

The electrolyte salt is an ionizable lithium salt and may be represented by Li⁺X⁻. X⁻ may include an anion selected from the group consisting of F⁻, Cl⁻, Br⁻, NO₃⁻, N(CN)₂⁻, BF₄⁻, ClO₄⁻, AlO₄⁻, AlCl₄⁻, PF₆⁻, SbF₆⁻, AsF₆⁻, BF₂C₂O₄⁻, BC₄O₈⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, C₄F₉SO₃⁻, CF₃CF₂SO₃⁻, (CF₃SO₂)₂N⁻, (F₂SO₂)₂N⁻, CF₃CF₂(CF₃)₂CO⁻, (CF₃SO₂)₂CH, CF₃(CF₂)₇SO₃⁻, CF₃CO₂⁻, CH₃CO₂⁻, SCN⁻, (CF₃CF₂SO₂)₂N⁻, and the like.

### Examples of Lithium Salt

For example, the lithium salt may be any one selected from the group consisting of LiTFSI, LiCl, LiBr, LiI, LiClO₄, lithium tetrafluoroborate (LiBF₄), LiB₁₀Cl₁₀, lithium hexafluorophosphate (LiPF₆), LiAsF₆, LiSbF₆, LiAlCl₄, LiSCN, LiCF₃CO₂, LiCH₃SO₃, LiCF₃SO₃, LiN(SO₂CF₃)₂, LiN(SO₂C₂F₅)₂, LiC₄F₉SO₃, LiC(CF₃SO₂)₃, (CF₃SO₂)₂NLi, lithium chloroborate, lithium lower aliphatic carboxylate, lithium imide 4-phenylborate, lithium bis(oxalato)borate (LiBOB), lithium difluoro(oxalato)borate (LiDFOB), lithium bis(fluorosulfonyl)imide (LiFSI), lithium 4,5-dicyano-2-(trifluoromethyl)imidazolide (LiTDI), lithium bis(trifluoromethanesulfonyl)imide (LiTFSI), and lithium bis(fluorosulfonyl)imide (LiFSI), the like, and combinations thereof. The electrolyte salt can include any combination of the salts described herein.

### Amount of Electrolyte Salt

The solid electrolyte layer 106 can include at or about 0, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, or 400 parts, all based on the total weight of the solid electrolyte layer 106. In embodiments, electrolyte salt in the solid electrolyte layer 106 may be within a range formed by selecting any two numbers listed above or by selecting any two numbers between about 0 parts and about 400 parts, or about 60 parts and 400 parts, based on the total weight of the solid electrolyte layer 106.

### Ion Conductivity of Solid Electrolyte Layer

The solid electrolyte layer 106 may have a suitable reduction stability and/or ion conductivity. Since the solid electrolyte layer 106 mainly functions to transport lithium ions between electrodes, the solid electrolyte layer 106 can include a desirable ion conductivity of at, about, or greater than, for example, 10⁻⁷ S/cm, 10⁻⁶ S/cm, 10⁻⁵ S/cm, or 10⁻⁴ S/cm.

### Thickness of Solid Electrolyte Layer

A thickness, t₆, of the solid electrolyte layer 106 can be at or about 1, 2, 3, 4, 5, 6, 7, 8, 9, 10, 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850,860, 870, 880, 890, 900, 910, 920, 930, 940, 950, 960, 970, 980, 990, or 1,000 μm. In embodiments, the thickness, t₆, of the solid electrolyte layer 106 may be within a range formed by selecting any two numbers listed above or by selecting any two numbers in the range of between 0 and at or about 1,000 μm, e.g., between about 5 μm and about 1,000 μm, about 30 μm and about 100 μm, or about 30 μm and about 50 μm.

### Unfinished Product

The cell 101 as shown in FIG. 1 can be provided as an unfinished product. In embodiments, the cell 101 is stored, transported, and/or delivered to a reseller, customer, or the like that finishes manufacture of a battery assembly or product comprising the cell 101. In other embodiments, the cell 101 is a finished battery assembly or product.

### Sealing Battery

An enclosure 112 of the solid state battery can be sealed to finish making the solid state battery 100 such that it will work as a battery. The sealing process may involve various techniques to ensure the internal components are protected from external environmental factors and to maintain the integrity of the battery structure. For example, the enclosure 112 may be hermetically sealed using methods such as laser welding, ultrasonic welding, or adhesive bonding. In some cases, the sealing process may also include the introduction of a protective atmosphere or the removal of air to create a vacuum within the enclosure. This sealing step may be helpful for preventing moisture ingress, which could potentially degrade the performance of the sulfide-based solid electrolyte. Additionally, the sealing process may incorporate safety features such as pressure relief mechanisms to manage any potential gas build-up during battery operation.

### After Sealing Battery

Once properly sealed, the solid state battery 100 is ready for final quality control checks, which may include electrical testing, leak detection, and visual inspections. After passing these checks, the solid state battery 100 could be packaged and sold as a finished product, ready for integration into various electronic devices, electric vehicles, energy storage systems, and so forth.

### Battery Configuration

The solid state battery 100 is provided in various configurations to suit different applications and device requirements. In some aspects, the battery may be manufactured in a cylindrical form, which can be advantageous for certain types of portable electronics or automotive applications. Alternatively, the solid state battery 100 may be produced in a prismatic form, which can allow for more efficient space utilization in devices with rectangular form factors. In other cases, a pouch form may be employed, offering flexibility in shape and potentially reducing overall battery weight. The pouch form may further be especially suitable for solid state batteries due to easier application and control of uniform pressures within the battery.

### Choice of Configuration

The choice of configuration may depend on factors such as the intended use, space constraints, thermal management requirements, and manufacturing considerations. In some embodiments, hybrid or custom configurations combining elements of different forms may be utilized as desired. The versatility in battery form factors can enable the integration of solid state batteries into a wide range of products, from small wearable devices to large-scale energy storage systems.

### Voltage

The solid state battery 100 is configured to output a voltage of at or about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 48, 50, 55, 60, 65, 70, 75, 80, 85, 90, 95, 96, 100, 110, 120, 130, 140, 150, 160, 170, 180, 190, 200, 210, 220, 230, 240, 250, 260, 270, 280, 290, 300, 310, 320, 330, 340, 350, 360, 370. 380, 390, 400, 410, 420, 430, 440, 450, 460, 470, 480, 490, or 500 V. In embodiments, the output voltage of the solid state battery 100 may be within a range formed by selecting any two numbers listed above or by selecting any two numbers in the range of between 0 and at or about 500 V, e.g., between about 1 V DC and about 500 V DC.

### Capacity

The solid state battery 100 ay be configured to have a capacity of at, about, or greater than 100, 110, 120, 130, 140, 150, 160, 170, 180, 190, 200, 210, 220, 230, 240, 250, 260, 270, 280, 290, or 300 mAh/g. In embodiments, the output voltage of the solid state battery 100 may have a capacity formed by selecting any two numbers listed above or by selecting any two numbers in the range of between 0 and 300 mAh/g or between 0 and about 300 mAh/g, e.g., between about 100 mAh/g and about 300 mAh/g.

### Volume Expansion Calculation

The solid state battery 100 may be configured to have a desirable volume expansion rate. The volume expansion rate may be calculated from a change in thickness after the first cycle of charging and discharging compared to the initial thickness. The volume expansion rate may be a ratio of the thickness change to the initial thickness. A first cycle of charging and discharging is performed by CC-CV charging a battery at 0.1 C and cutting off at 4.25 to 4.4 V and 0.02 C, and CC discharging the battery at 0.1 C and cutting off at 3 V. The volume expansion rate is calculated by Equation 1 below in which A may represent a thickness before charging and discharging and B may represent a thickness after charging and discharging. The thickness may be measured using a Mauser micrometer or a scanning electron microscope (SEM).

Volume expansion rate=[(B−A)/A]×100 Equation 1:

### C-Rate

C-rate as used herein refers to the rate at which the battery is discharged relative to its maximum capacity. For example, a 1 C rate means the discharge current will discharge the entire battery within one hour. That is, for a battery with a capacity of 20 Amp-hrs, a discharge current at a 1 C would be 20 Amps.

### C-Rate of the Battery

The solid state battery 100 can comprise a C-rate of at, about, or greater than 0.33, 0.4, 0.5, 0.6, 0.7, 0.8, 0.9, 1, 2, 3, 4, or 5. In embodiments, the C-rate of the solid state battery 100 can be within a range formed by selecting any two numbers listed in the immediately previous sentence, e.g., between about 0.33 and about 5.

### Other Examples for Volumetric Expansion

Other ways to measure and calculate the volume expansion rate for a solid state battery may include using volumetric expansion measurement (e.g., gas pycnometry), in-situ dilatometry, X-ray tomography, strain gauge measurements, optical methods (e.g., digital image correlation or laser interferometry), pressure-based methods, and electrochemical strain microscopy.

### Conflicts

The additional features, embodiments and examples discussed below will be applicable to various aspects of the invention discussed above. In case there is a conflict between information in the foregoing discussions and information in the following discussions, however, the information in the foregoing section should apply.

### EXAMPLES

Examples will be described more fully hereinafter so that the present disclosure can be understood with ease. However, the following examples are for illustrative purposes only and the scope of the present disclosure is not limited thereto.

### Example 1: Making Composite Material

### Example 1-1: Making Composite Material Containing LPSCZ

The cathode, comprised of active material, such as Li₂S is obtained from Sigma Aldrich. A solid electrolyte material, LPSCl is obtained from NEI Corporation and is milled using a planetary ball mill prior to use. Acetylene Black (AB) carbon serves as the conductive agent and is obtained from Sigma Aldrich. Both Li₂S and AB are dried overnight under vacuum at 80° C. to remove excess moisture. To confirm morphologies and sizes pre- and post-milling, scanning electron microscopy (SEM) was conducted for these materials.

SEM was performed on a FEI Apreo and/or FEI Scios DualBeam focused ion beam (FIB)/SEM with 5 kV accelerating voltage and 0.1 nA beam current for powders and pellets. Powder and pellet samples were prepared in an argon-filled glovebox and transferred using the air-tight transfer arm to avoid any air exposure. For the FIB cross-sectional images, milling was done under cryogenic conditions (−180° C.) where Ga was used as an ion beam source. Parameters used for all milling conditions of 30 kV, 65 nA, with the subsequent cross-section cleaning performed with 30 kV, 15 nA.

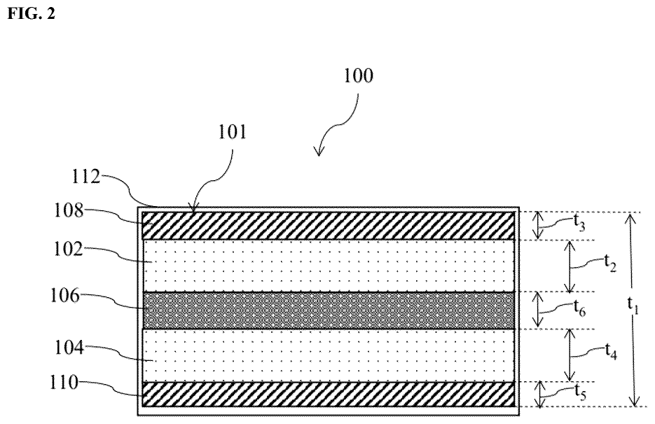

FIG. 3A is an SEM image of the obtained Li₂S particles. FIG. 3B is an SEM image of the milled LPSCl particles. FIG. 3C is an SEM image of the AB carbon. The obtained Li₂S material is milled at 400 RPM for 10 hours to reduce its size from about 30 μm to about 1 μm using a high energy ball-mill in air-tight zirconia jars with zirconia stabilized milling media. FIG. 3D is an SEM image of the Li₂S material as received at a different magnification from that in FIG. 3A. FIG. 3E is an SEM image of the milled Li₂S material, which has reduced particle size and is used to better compare with the composite material.

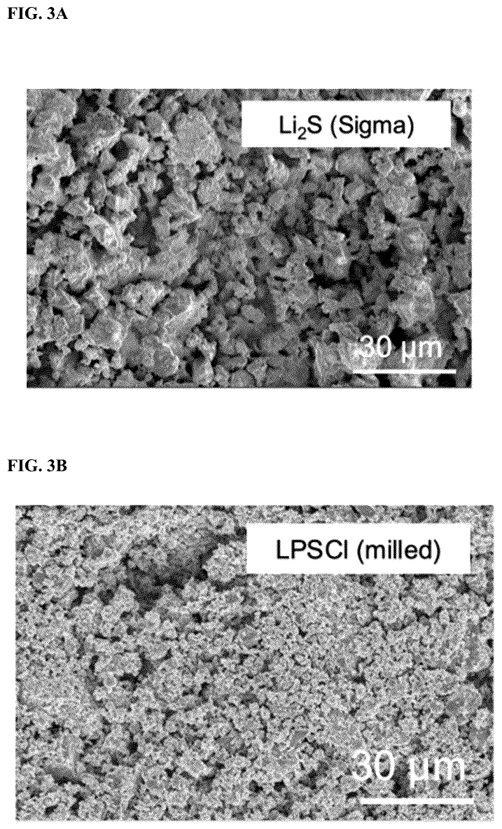

Then, a 30 wt % Li₂S, 20 wt % carbon, and 50 wt % LPSCl are hand mixed with a mortar and pestle and then mixed in a milling container together with the milling media, milling balls, and are milled at a speed of 500 RPM for 1 hour. FIG. 4 is a diagram of the ball-milling.

### Example 1-2: Making Composite Material Containing LPSF

Example 1-1 is repeated, except that LPSCl is replaced by LPSF.

### Example 1-3: Making Composite Material Containing LPSBr

Example 1-1 is repeated, except that LPSCl is replaced by LPSBr.

### Example 1-4: Making Composite Material Containing LPSI

Example 1-1 is repeated, except that LPSCl is replaced by LPSI.

### Example 2: Characterization of Composite Material

### Example 2-1: X-Ray Diffraction

XRD measurements were collected by a Bruker SMART instrument using Mo Kα (λ=0.71 Å) radiation and a Platinum 135 CCD detector at the UCSD X-Ray Crystallography Department. The measurements were performed from 5 to 90° 2θ and collected at ambient temperature. Samples were prepared in an argon-filled glovebox using 0.7 mm boron capillaries, and flame sealed to ensure air-tight measurements of sensitive samples.

XRD analysis is conducted for milled Li₂S/LPSCl/C mixture, milled Li₂S/LPSCl mixture, LPSCl, and Li₂S, respectively. Samples are prepared in an argon glovebox by loading the milled composite powders in 0.5-0.7 mm boron rich capillaries, then flame sealed for air-tight measurements. XRD measurements were collected over a 5-50° 2θ range on a Bruker ApexII-Ultra CCD microfocus Rotating Anode instrument with Mo Kα (k=0.7107 Å) radiation.

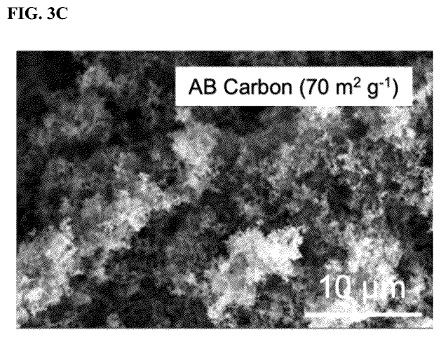

FIG. 5 shows the XRD results of milled Li₂S/LPSCl/C mixture, milled Li₂S/LPSCl mixture, LPSCl, and Li₂S. These results show that the XRD peaks of LPSCl are not present in the XRD of the milled Li₂S/LPSCl/C mixture, which indicate at least a reduction in crystallinity of the LPSCl in the milled composite material. Linear Combination Fitting (LCF) results show that half of the LPSCl is converted to LPS after the milling process. The XRD results also show that the XRD peak of LPS is not present in the XRD of the milled Li₂S/LPSCl/C mixture, which indicates that the LPS present in the milled composite material has a low crystallinity or nanocrystallinity. XRD of the composite without carbon was also measured to eliminate any masking of features where a small broad peak at 13.7° 2θ was detected. This could be attributed to either the main diffraction peak (311) of LPSCl or the main diffraction peak (211) of β-LPS, which are both present at 13.7° 2θ.

### Example 2-2: Synchrotron X-Ray Absorption Spectroscopy (XAS)

The tender X-ray absorption spectroscopy (XAS) measurements were conducted at Taiwan Light Source (TLS) beamline 16A1 of the National Synchrotron Radiation Research Center (NSRRC) in Hsinchu, Taiwan. The beamline uses a double-crystal Si (111) monochromator for the photon energy range from 2 to 8 keV. All samples were sealed in a pouch made of 2.5 um thick Mylar® film inside an Ar-filled glovebox to prevent the samples from exposure to air. Each sample was mounted onto the holder and placed in the measuring chamber at an angle of 45° to the incident X-ray beam. The chamber is constantly purged with He to reduce the X-ray attenuation for at least 45 minutes before collecting the XAS data. The Sulfur K-edge X-ray absorption near-edge structure (XANES) spectra were collected in the total fluorescence yield (TFY) mode using a Lytle detector with a scanning step of 0.2 eV. The photon energy was calibrated to 2472 eV (maximum in the 1st derivative) at the S K-edge using elemental sulfur. The XANES spectra background subtraction, normalization, and the Linear Combination Fit (LCF) were performed on Athena software.

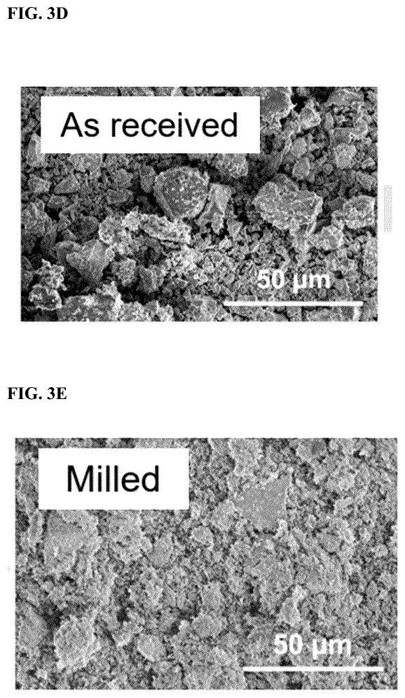

Synchrotron XAS is conducted for the composite material made in Example 1-1. FIGS. 6A to 6F showing the synchrotron XAS results of the composite material made in Example 1-1. FIG. 6A is the reference spectra, FIGS. 6B-6D show the XAS of the pristine, charged, and discharged (after 1 cycle) composite material. FIG. 6E is the raw spectra of S k-edge, and FIG. 6F shows the linear combination fitting results. The results show that despite degradation of LPSCl, the composite is reversible. After discharging, peaks attributed to Li₂S, from the reference spectra, are observed at 2474.2 eV and 2476.8 eV followed by a severe reduction of the elemental sulfur peak, aligning well with the XRD results. After charging, features assigned to Li₂S are no longer present and an increase in the elemental sulfur peak is observed. The reversibility of the Li₂S cathode when paired with LPSCl is unmistakable. After charging, features assigned to α-Sulfur are pronounced at 2473.6 eV and 2480 eV, with intensity features assigned to Li₂S being reduced. After the discharge process, the spectra recover back to the pristine state with clear features restored at 2474.2 eV and 2476.8 eV ascribed to Li₂S. LCF results shows that pristine sample is half of LPSCl and half LPS. 27.5 wt. % of LPS was detected in the pristine state where a portion of LPSCl was found to be decomposed. This is consistent with the XRD in FIG. 5, where diffraction peaks associated with LPSCl were undetectable indicating either a reduction of crystallinity or decomposition. The results show that the LPS/LPSCl mixture retains its ionic conductivity and can act as a catalyst to mediate the oxidation of Li₂S. This is shown in the charging LCF results, where Li₂S is highly utilized, and more sulfur is formed than expected due to the oxidation of LPS but reverts almost back to its pristine state. These results support the excellent reversibility of the lithium sulfur system, attributed to the oxidation mediative feature of the LPSCl electrolyte.

### Example 3: Making Cathode

### Example 3-1: Making Cathode Containing LPSCl

The ball-milled cathode composite material from Example 1-1 is pressed under 375 MPa in custom cell holder to make a cathode for a solid-state battery. The loading of the cathode can be tuned depending on the target battery capacity.

### Example 3-2: Making Cathode Containing LPSF

Example 3-1 is repeated except that the composite material from Example 1-2 is used.

### Example 3-3: Making Cathode Containing LPSBr

Example 3-1 is repeated except that the composite material from Example 1-3 is used.

### Example 3-4: Making Cathode Containing LPSI

Example 3-1 is repeated except that the composite material from Example 1-4 is used.

### Example 4: Making All Solid-State Battery

### Example 4-1: Making Battery Using Cathode Containing LPSCZ

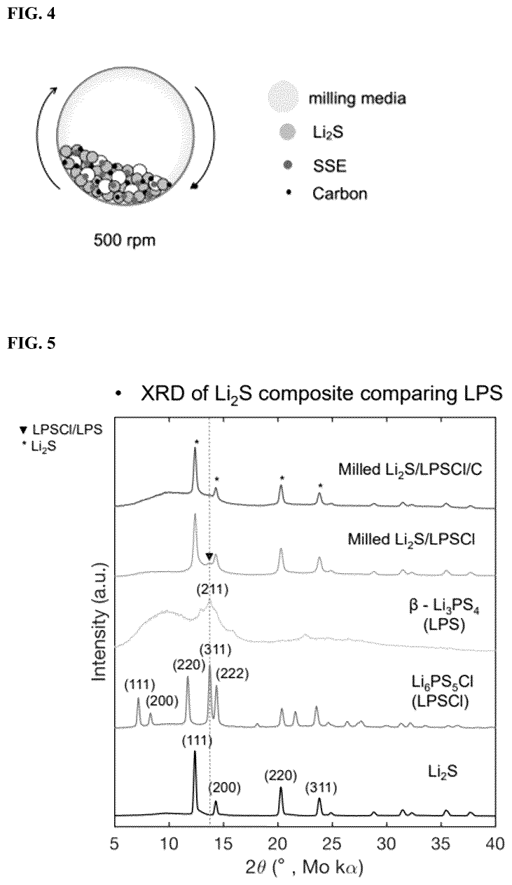

To make the all-solid-state battery, the composite cathode from Example 3-1, a solid electrolyte LPSCl layer, and an anode electrode, comprising of Li_{0.5}In alloy or silicon are pressed together at varying pressures in a plunger cell to make an all-solid-state battery, as shown in FIG. 7. First, 50-75 mg of LPSCl is pressed under a pressure of 75 MPa to create the separator layer. The cathode and anode powder are then added on both sides of the separator layer and pressed to 75 MPa.

### Example 4-2: Making Battery Using Cathode Containing LPSF

Example 4-1 is repeated, except that the composite cathode from Example 3-2 is used.

### Example 4-3: Making Battery Using Cathode Containing LPSBr

Example 4-1 is repeated, except that the composite cathode from Example 3-3 is used.

### Example 4-4: Making Battery Using Cathode Containing LPSI

Example 4-1 is repeated, except that the composite cathode from Example 3-4 is used.

### Example 5: Two-Step Milling

### Example 5-1: Two-step Milling of 40% Li₂S/LiI and LPS

A mixture of Li₂S and LiI is milled together at 500 RPM, followed by milling the solid electrolyte LPS at 300 RPM.

### Example 5-2: Two-Step Milling of 40% Li₂S/LiI and LPSCZ

Example 5-1 is repeated, except that LPS is replaced by LPSCl.

### Example 5-3: Two-Step Milling of 30% Li₂S/LiI and LPSCZ

Example 5-2 is repeated, except that the weight % of Li₂S in the composite material is 30%.

### Example 5-4: Making Battery Using 40% Li₂S/LiI/LPS Composite Material

Example 4 is repeated using composite material from Example 5-1.

### Example 5-5: Making Battery Using 40% Li₂S/LiI/LPSCl Composite Material

Example 5-4 is repeated except the composite material from Example 5-1 is replaced by the composite material from Example 5-2.

### Example 5-6: Making Battery Using 30% Li₂S/LiI/LPSCl Composite Material

Example 5-4 is repeated except the composite material from Example 5-1 is replaced by the composite material from Example 5-3.

### Example 5-7: Measuring Specific Capacity of Battery Containing 40% Li₂S/LiI/LPS Composite Material

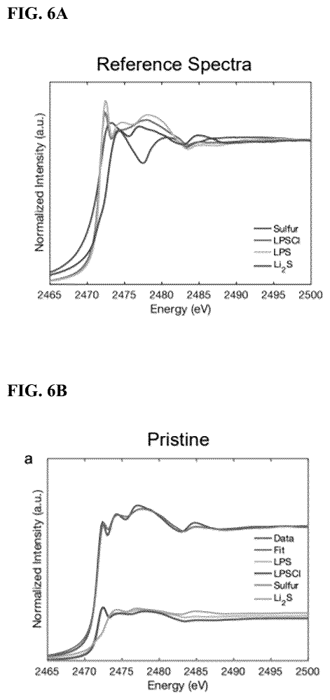

The specific capacity is measured for the battery from Example 5-4 by applying a constant current with a cutoff voltage between an upper voltage cutoff of 3V and lower cutoff of 1.3V. The battery was cycled under 75 MPa at room temperature with a Li_{0.5}In anode. Capacity utilization and cell cycling was evaluated using Neware Instrument cyclers (CT-4008T). FIG. 8 shows that this battery, which includes LiI and LPS within the cathode, exhibits high polarization and low utilization due to limited ionic conductivity of LPS, resulting in slow conversion kinetics of Li₂S.

### Example 5-8: Measuring Specific Capacity of Battery Containing 40% Li₂S/LiI/LPSCl Composite Material

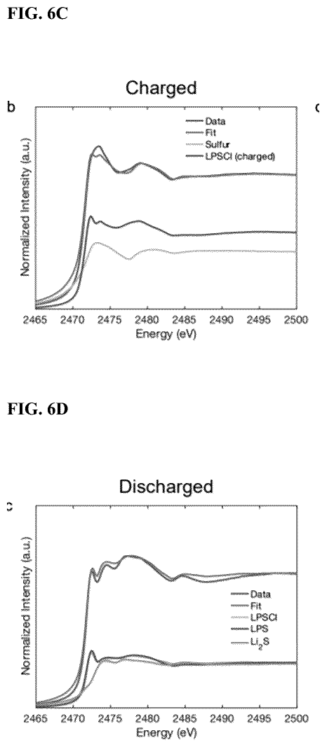

Example 5-7 is repeated for the battery from Example 5-5. FIG. 9 shows the voltage profiles of the battery using LPSCl instead of LPS, where an improvement in utilization and reduction in cell polarization is obtained due to the improved mechanical properties and ionic conductivity of LSPCl, leading to better interfacial contact between all components (Li₂S, carbon, LPSCl) for Li₂S conversion. However, the addition of LiI within the composite still leads to a Li₂S utilization lower than the theoretical (600 mAh g⁻¹ vs 1200 mAh g⁻¹).

### Example 5-9: Measuring Specific Capacity of Battery Containing 30% Li₂S/LiI/LPSCl Composite Material

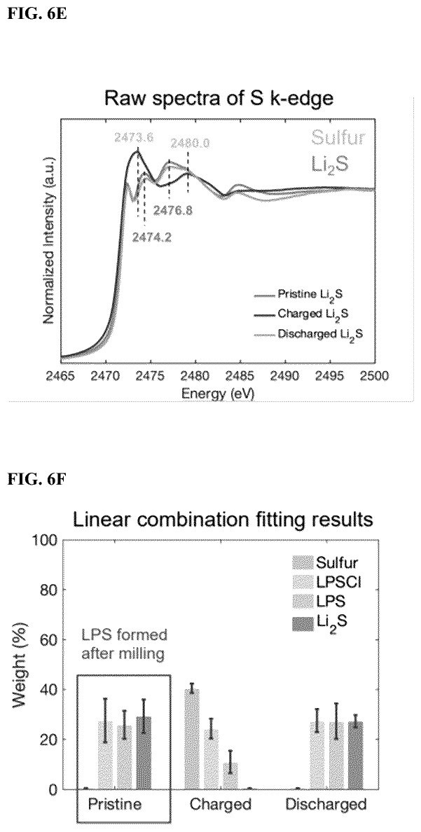

Example 5-7 is repeated for the battery from Example 5-6. FIG. 10 shows specific capacity measured for this battery. Compared to the batteries in Examples 5-4 and 5-5, more solid electrolyte material is used in this battery to increase ionic conduction of this battery, and thus utilization of the battery is improved. However, this battery still exhibits poor cycling stability due to the instability of the Li₂S/LiI/LPSCl composite, evidence of mechanical and electrochemical degradation. The addition of LiI within the composite results in poor cycling stability, likely blocking sites for Li₂S conversion coupled with an insufficient conductive network.

### Example 6: Mixing Methods

### Example 6-1: Making Composite Material by Hand-mixing

The hand-mixed composite is made by mixing Li₂S cathode, carbon, and LPSCl in a mortar and pestle for an extended period ranging from 30 to 60 minutes depending on the batch size.

### Example 6-2: Making Composite Material by One-Step Ball-Milling

Example 1-1 is repeated with Li₂S, carbon, and LPSCl solid electrolyte. The powders are hand-mixed with a mortar and pestle and then milled for 1 hour at 500 RPM with 5 mm milling media with a batch size to ball ratio 30:1. Longer milling durations result in the degradation of the LPSCl solid electrolyte, destroying conduction pathways and contributing to a reduction in ionic conductivity.

### Example 6-3: Making Composite Material by Two-Step Ball-Milling

Example 5-1 is repeated with Li₂S, carbon, and LPSCl. First, Li₂S cathode is milled with carbon for 1 hour at 500 RPM. The LPSCl solid electrolyte is then incorporated with the Li₂S/carbon composite and lightly milled for 30 minutes at 300 RPM.

### Example 6-4: Making Battery Using Composite Material Prepared by Hand-Mixing

Example 4 is repeated using the composite material from Example 6-1.

### Example 6-5: Making Battery Using Composite Material Prepared by One-Step Ball-Milling

Example 6-4 is repeated using composite material from Example 6-2.

### Example 6-6: Making Battery Using Composite Material Prepared by Two-Step Ball-Milling

Example 6-4 is repeated using the composite material from Example 6-3.

### Example 6-7: Measuring Specific Capacity of Battery of Example 6-4

Example 5-7 is repeated for the battery from Example 6-4.

### Example 6-8: Measuring Specific Capacity of Battery of Example 6-5

Example 5-7 is repeated for the battery from Example 6-5.

### Example 6-9: Measuring Specific Capacity of Battery of Example 6-6

Example 5-7 is repeated for the battery from Example 6-6.

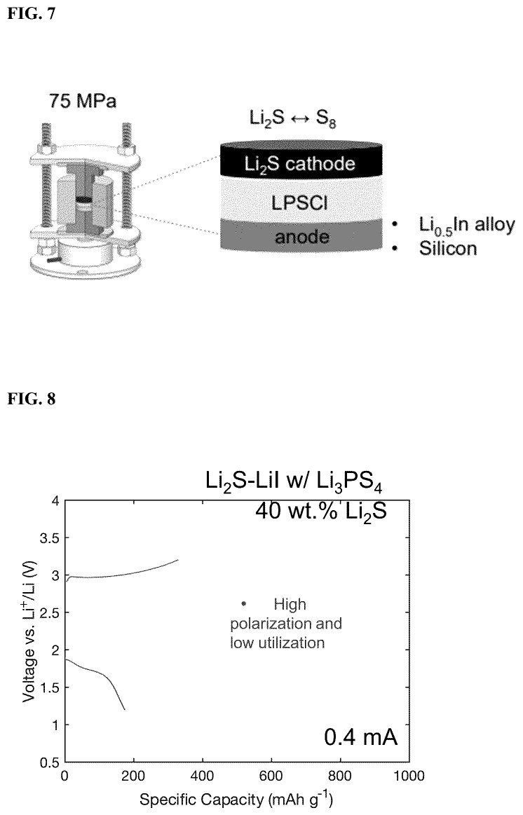

FIG. 11 shows the comparison of the specific capacities of the batteries of Examples 6-4, 6-5, and 6-6 obtained at current densities of 0.05 mA cm⁻². The results show that the mixing method for the electrode composite material greatly affects the specific capacity/utilization of Li₂S cathode, and thus the energy output and electrochemical performance of the battery using the electrode composite material in Example 6-2. It can be seen using Example 6-2 process results in additional features from the LPSCl solid electrolyte during the battery discharge. Here, LPSCl undergoes electrochemical reduction, potentially forming Li₂S and LPS, which contributes to the battery capacity and stable cycling performance.

### Example 7: Halide Solid Electrolyte

### Example 7-1: Making Composite Material

Example 1-1 is repeated, except that LPSCl is replaced by Li₃YCl₆ (LYC)

### Example 7-2: Making Cathode

Example 3-1 is repeated using the composite material prepared in Example 7-1.

### Example 7-3: Making Battery With Li—In Alloy Anode

Example 4-1 is repeated using the cathode prepared in Example 7-2.

### Example 7-4: Making Battery With Si Anode

Example 7-3 is repeated except a Si anode is used.

### Example 7-5: Measuring Specific Capacity

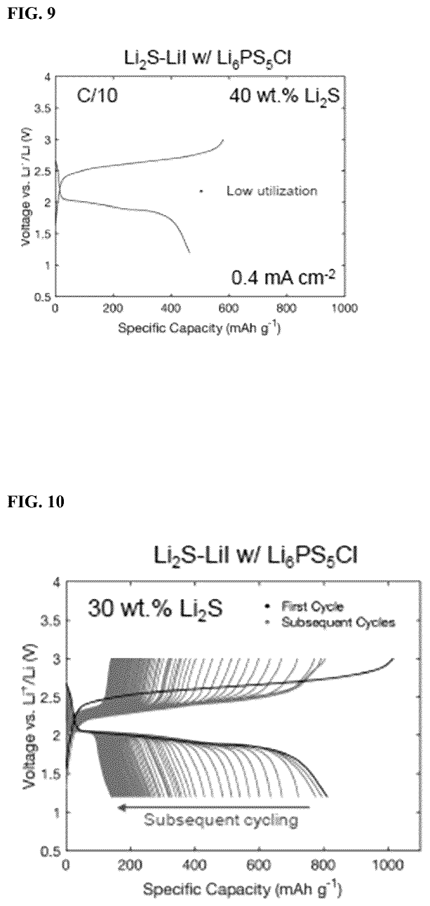

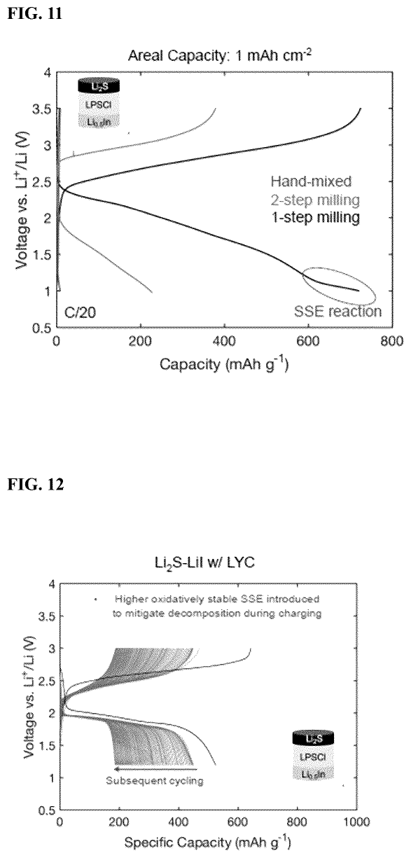

Example 5-7 is repeated for the batteries made in Examples 7-3 and 7-4. FIG. 12 shows the specific capacity measured for the battery made in Example 7-3 with repeated cycles and poor cycling stability. FIG. 13 shows the specific capacity measured for the battery made in Example 7-4. The use of the Si anode results in large cell resistance, likely due to the poor mechanical properties (low elastic modulus and densification) of LYC. The results show that despite the use of LYC, severe capacity loss is still observed. This is attributed to LYC not being reductively stable during the battery discharge process, leading to a decreased ionic conduction within the composite.

### Example 8: Cathode Formulation

### Example 8-1: Making Composite Material with 30% of Li₂S

Example 1-1 is repeated with Li₂S in 30 wt % of the total weight of the composite material.

### Example 8-2: Making Composite Material with 35% of Li₂S

Example 1-1 is repeated with Li₂S in 35 wt % of the total weight of the composite material.

### Example 8-3: Making Composite Material with 40% of Li₂S

Example 1-1 is repeated with Li₂S in 40 wt % of the total weight of the composite material.

### Example 8-4: Making Composite Material with 50% of Li₂S

Example 1-1 is repeated with Li₂S in 45 wt % of the total weight of the composite material.

### Example 8-5: Making Composite Material with 60% of Li₂S

Example 1-1 is repeated with Li₂S in 60 wt % of the total weight of the composite material.

### Example 8-6: Making Composite Material with 70% of Li₂S

Example 1-1 is repeated with Li₂S in 70 wt % of the total weight of the composite material.

### Example 8-7: Making Cathodes

Example 3-1 is repeated using the composite materials made in Examples 8-1 to 8-6.

### Example 8-8: Making Batteries

Example 4-1 is repeated using the cathodes prepared in Example 8-7.

### Example 8-9: Measuring Specific Capacities

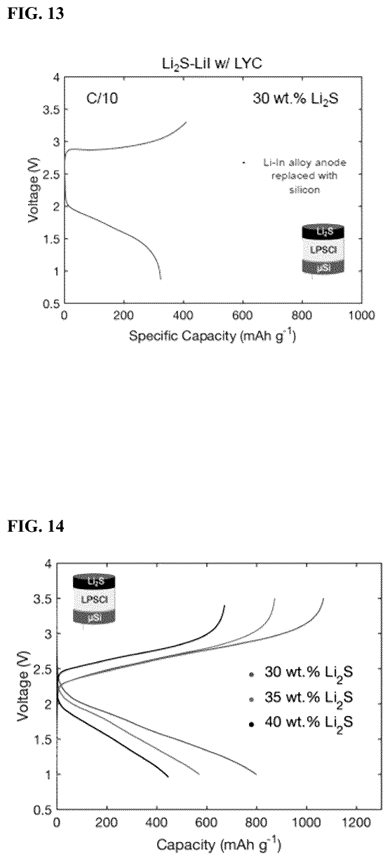

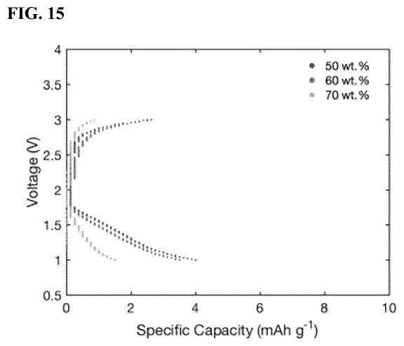

Example 7-4 is repeated for the batteries made in Example 8-8. FIG. 14 shows the specific capacities measured for batteries with 30, 35, and 40 wt % of Li₂S. FIG. 15 shows the specific capacities measured for batteries with 50, 60, and 70 wt % of Li₂S. These results show that the appropriate wt. % range for Li₂S is 30 to 40 wt. % shown with slight reduction in obtained capacity; and with above 40 wt. % Li₂S, the batteries cannot cycle, likely due to an insufficient ionically conductive network in the cathode from the limited volume of LSPCl. Due to the volume contraction and expansion of Li₂S during charge and discharge, sufficient volume provided by the solid electrolyte, is necessary to accommodate these volume changes and maintain interfacial contact for lithium-ion conduction within the cathode composite. This is why the 30-40 wt. % compositions deliver higher utilization and improved electrochemical performance.

### Combinations and Characteristics Included

Various features and characteristics are described in this specification to provide an understanding of the composition, structure, production, function, and/or operation of the present disclosure, which includes the disclosed compositions, coatings, and methods. It is understood that the various features and characteristics of the present disclosure described in this specification can be combined in any suitable manner, regardless of whether such features and characteristics are expressly described in combination in this specification. The Inventors and the Applicant expressly intend such combinations of features and characteristics to be included within the scope of the present disclosure described in this specification. As such, the claims can be amended to recite, in any combination, any features and characteristics expressly or inherently described in, or otherwise expressly or inherently supported by, this specification. Furthermore, the Applicant reserves the right to amend the claims to affirmatively disclaim features and characteristics that may be present in the prior art, even if those features and characteristics are not expressly described in this specification. Therefore, any such amendments will not add new matter to the specification or claims and will comply with the written description, sufficiency of description, and added matter requirements.

### INCORPORATED BY REFERENCE

Any patent, publication, or other document identified in this specification is incorporated by reference into this specification in its entirety unless otherwise indicated but only to the extent that the incorporated material does not conflict with existing descriptions, definitions, statements, illustrations, or other disclosure material expressly set forth in this specification. As such, and to the extent necessary, the express disclosure as set forth in this specification supersedes any conflicting material incorporated by reference. Any material, or portion thereof, that is incorporated by reference into this specification but that conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference. The amendment of this specification to add such incorporated subject matter will comply with the written description, sufficiency of description, and added matter requirements.

### Illustration of Various Aspects

While the present disclosure provides descriptions of various specific aspects for the purpose of illustrating various aspects of the present disclosure and/or its potential applications, it is understood that variations and modifications will occur to those skilled in the art. Accordingly, the present disclosure herein should be understood to be at least as broad as claimed and not as more narrowly defined by particular illustrative aspects provided herein.

What is claimed is:

1. A method of making an electrode composite material, the method comprising:
providing in a ball-milling container a mixture that comprises Li₂S particles, carbon particles, and chlorinated lithium phosphorous sulfide (LPSCl) particles containing an LPSCl compound, wherein the LPSCl particles have crystallinity which can be confirmed with XRD of the LPSCl particles or the mixture showing XRD peaks (111) at 2θ of about 7.5°, (200) at 2θ of about 8°, (220) at 2θ of about 12°, (311) at 2θ of about 13.5°, and (222) at 2θ of about 14.5°, wherein the mixture does not comprise lithium phosphorous sulfide (LPS) particles made of an LPS compound; and
ball-milling the mixture in the ball-milling container to provide a ball-milled composite material such that at least part of the LPSCl compound contained in at least part of the LPSCl particles is converted to the LPS compound and further such that XRD of the ball-milled composite material shows none of the XRD peaks (111) at 2θ of about 7.5°, (200) at 2θ of about 8°, (220) at 2θ of about 12°, (311) at 2θ of about 13.5°, and (222) at 2θ of about 14.5°.

2. The method of claim 1, wherein the ball-milled composite material comprises solid electrolyte (SSE) particles, wherein the SSE particles comprise first particles containing solely the LPSCl compound, second particles containing solely the LPS compound, and third particles containing both the LPS and LPSCl compounds.

3. The method of claim 1, wherein XRD of the ball-milled composite material does not show XRD peak (211) at 2θ of about 13.7°, which indicates crystallinity of the LPS compound.

4. The method of claim 1, wherein the mixture consists essentially of the Li₂S particles, the LPSCl particles, and the carbon particles.

5. The method of claim 1, wherein the mixture consists of the Li₂S particles, the LPSCl particles, and the carbon particles.

6. The method of claim 1, wherein the Li₂S particles after the ball-milling of the mixture have particle sizes in a range of about 100 nm to about 1 μm.

7. The method of claim 1, wherein the carbon particles comprise one selected from the group consisting of acetylene black (AB) carbon, vapor grown carbon fiber (VGCF), carbon nanotube (CNT), Ketjen black (KB) carbon, and combinations thereof.

8. The method of claim 1, wherein the ball-milling converts about 30 wt % to about 70 wt % of the LPSCl compound to the LPS compound.

9. The method of claim 1, wherein the mixture prior to the ball-milling comprises:
about 20% to about 40% by weight of the Li₂S particles based on a total weight of the mixture; and
about 15% to about 20% by weight of the carbon particles based on the total weight of the mixture.

10. The method of claim 1, wherein the ball-milling of the mixture is conducted at about 300 to about 550 RPM for about 1 minute to about 20 hours.

11. The method of claim 1, wherein the mixture prior to the ball-milling comprises:
about 20% to about 40% by weight of the Li₂S particles based on a total weight of the mixture, and
about 15% to about 20% by weight of the carbon particles based on the total weight of the mixture;
wherein the carbon particles comprise one selected from the group consisting of acetylene black carbon, VGCF, CNT, Ketjenblack, and combinations thereof;
wherein the LPSCl particles prior to the ball-milling have particle sizes in a range of about 1 μm to about 30 μm;
wherein the Li₂S particles prior to the ball-milling have particle sizes in a range of about 250 nm to about 25 μm;
wherein the ball-milling of the mixture is conducted at about 300 to about 550 RPM for about 1 hour to about 5 hours; and
wherein the ball-milling converts about 30 wt % to about 70 wt % of the LPSCl compound to the LPS compound.

12. The method of claim 1, wherein the mixture prior to the ball-milling comprises:
about 25% to about 35% by weight of the Li₂S particles based on a total weight of the mixture, and
about 18% to about 20% by weight of the carbon particles based on the total weight of the mixture;
wherein the carbon particles comprise acetylene black carbon;
wherein the ball-milling of the mixture is conducted at about 400-500 RPM for about 1-5 hours; and
wherein the ball-milling converts about 40-60 wt % of the LPSCl compound to the LPS compound.

13. An electrode composite material comprising:
Li₂S particles containing a Li₂S compound;
carbon particles; and
solid electrolyte (SSE) particles comprising first particles containing solely a chlorinated lithium phosphorous sulfide (LPSCl) compound, second particles containing solely a lithium phosphorous sulfide (LPS) compound, and third particles containing both the LPS and LPSCl compounds,
wherein XRD of the electrode composite material shows none of XRD peaks (111) at 2θ of about 7.5°, (200) at 2θ of about 8°, (220) at 2θ of about 12°, (311) at 2θ of about 13.5°, and (222) at 2θ of about 14.5° indicative of crystalline LPSCL.

14. The electrode composite material of claim 13, wherein XRD of the electrode composite material does not show XRD peak (211) at 2θ of about 13.7°, which indicates crystallinity of the LPS compound.

15. The electrode composite material of claim 13 comprising:
about 20% to about 40% by weight of the Li₂S particles based on a total weight of the electrode composite material; and
about 15% to about 20% by weight of the carbon particles based on the total weight of the electrode composite material.

16. The electrode composite material of claim 13, wherein the Li₂S particles have particle sizes in a range of about 100 nm to about 1 μm.

17. The electrode composite material of claim 13, wherein the carbon particles comprise one selected from the group consisting of acetylene black (AB) carbon, vapor grown carbon fiber (VGCF), carbon nanotube (CNT), Ketjen black (KB) carbon, and combinations thereof.

18. The electrode composite material of claim 13, wherein the carbon particles comprise AB carbon.

19. The electrode composite material of claim 13, wherein the carbon particles have a BET specific surface area of about 70 m²g⁻¹.

20. An electric vehicle comprising an all solid state battery comprising:
a cathode electrode comprising the electrode composite material of claim 13;
an anode electrode; and
a solid electrolyte layer positioned between the cathode electrode and the anode electrode and configured to enable transport of lithium ions between the cathode electrode and the anode electrode.
